(19) United States
(12) Patent Application Publication
(10) Pub. No.: US 2019/0177603 A1
(43) Pub. Date: Jun. 13, 2019

(54) ENVIRONMENTALLY ACCEPTABLE SURFACTANT IN AQUEOUS-BASED STIMULATION FLUIDS

(71) Applicant: SCHLUMBERGER TECHNOLOGY CORPORATION, Sugar Land, TX (US)

(72) Inventors: Carlos ABAD, Aberdeen (GB); Narmina FINN, Westhill (GB); Emlyn DOHERTY, Westhill (GB)

(21) Appl. No.: 15/753,984

(22) PCT Filed: Aug. 22, 2016
(86) PCT No.: PCT/US2016/047938

§ 371 Date: Feb. 21, 2018

Related U.S. Application Data
(60) Provisional application No. 62/208,067, filed on Aug. 21, 2015.

(51) Int. Cl. C09K 8/68; C09K 8/86; C09K 8/506; C09K 8/40

(52) U.S. Cl. CPC C09K 8/68; C09K 8/86; C09K 2208/30; C09K 8/40; C09K 2208/08; C09K 8/506

(57) ABSTRACT

A method of treating a subterranean formation penetrated by a wellbore is disclosed, wherein the method includes introducing a treatment fluid comprising at least a surfactant having at least a branched alcohol ethoxylated surfactant to the subterranean formation.

This application claims the benefit of U.S. Provisional Application Ser. No. 62/208,067 filed Aug. 21, 2015 entitled “Environmentally Acceptable Surfactant in Aqueous-Based Stimulation Fluids” to Abad et al. (Attorney Docket No. IS15.0272-US-PSP), the disclosure of the provisional application is incorporated by reference herein in its entirety.

### BACKGROUND

Hydrocarbons (oil, natural gas, etc.) are obtained from subterranean geologic formations (“reservoirs”) by drilling wells that penetrate the hydrocarbon-bearing formations. In the process of recovering hydrocarbons from subterranean formations, it is common practice to treat a hydrocarbon-bearing formations with pressurized fluids to provide enhanced flow path and or channels, i.e., to fracture the formation, and or to use such fluids to transport and place propping agents to facilitate flow of the hydrocarbons to the wellbore.

Oilfield operations requiring well treatment fluids may be performed in either a land or offshore environment, with the offshore environment receiving recent attention from an environmental perspective in various regions of the globe (North and South America, Continental Europe, Gulf of Mexico, Alaska, Canada, Oceania, or West Africa). One offshore environment in particular, the North Sea, has had for the last 30 years or so some of the most stringent environmental and discharge regulations in the world. Therefore, the regulations, parameters, criteria and test methods used to evaluate environmental compliance in the North Sea can and are being employed as benchmarks for environmental compliance in other geographic locations.

Any oilfield chemical that is used in the North Sea is registered with the respective country's regulatory body which assigns a rating or color classification to each chemical depending on its environmental and toxicological characteristics. Based on the chemical rating or color classification, the chemical will either be regarded as more or less environmentally friendly or unfriendly. In the North Sea, the classification techniques vary. For example, (1) Norway and Denmark follow color classification for chemical products, (2) United Kingdom (UK) follows color and letter ratings for organic and inorganic chemical products respectively and (3) Netherlands follows letter categories. In other words, even countries within a small geographic region have customized their classification system based upon a desire to differentiate environmentally friendly and unfriendly chemical products. Regardless of the classification system, each of the North Sea countries (Norway, Denmark, Netherlands and United Kingdom) employs the same three ecotoxicology tests criteria to determine whether a specific chemical may be classified as environmentally friendly. These three ecotoxicology tests describe whether a chemical product features, on a component level, (1) ≥60% biodegradation in seawater after 28 days, (2) little to no bioaccumulation potential among aquatic life (less than 3 partition coefficient (log Pow)) and (3) little to no-toxicity towards aquatic life (less than 10 mg/L). For convenience, the North Sea regulations are summarized below in Table 1.

TABLE 1
North Sea Regulations Interpretation*

| Test | Biodegradation | | | Bio- | | Toxicity- | |
|---|---|---|---|---|---|---|---|
| | | | | accumulation | | EC/LC50 | |
| Unit | % | | | Log Pow | | mg/L | |
| Result | <20 | 20-60 | >60 | <3 | >3 | <10 | >10 |
| Inference | Very bad | Bad | Good | Good | Bad | Bad | Good |

*As a rule of thumb, two or more “Good” results means that the compounds is acceptable, while two or more “Bad” results means that the compound is unacceptable. However, a compound having less than 20% biodegradation alone also means that the compound is unacceptable.

When each component in a chemical product passes the above-mentioned criteria, then the whole product is rated as Green or PLONOR (Pose Little Or NO Risk) in Norway and Denmark. When one of the components only meets two of the criteria, then the product can still receive ‘Yellow’ classification in Norway and Denmark, but still environmentally friendly. If the biodegradation in seawater is <20% after 28 days for any of the component, then the chemical products gets ‘red’ color classification or substitution warning (i.e., an environmentally unfriendly classification in the North Sea).

For example, surfactant described herein, may have various classification depending on the country. As defined by the UK regulations, the surfactant described below does not have a substitution warning and is classified as gold, or green or yellow as classified by Norway or Denmark, or WGK1 or WGK0 if classified in Germany. The surfactant described herein may also be considered PLONOR or “no subwarning”

Depending on the service performed, a well service operation may require a large amount of chemicals, which means that the introduction of environmentally friendly chemicals is mandatory. One unique situation requiring extensive improvement is the development and introduction of environmentally friendly surfactants compatible with stimulation operations to the North Sea.

Biodegradation and aquatic toxicity are important parameters for surfactants. The toxicity of surfactants against fish and microorganisms is supposed to be a result of the surface-active agents interacting with the gills or membranes, respectively. Provided that the surfactant is cleaved before it reaches the environment or is degraded rapidly under conditions found in nature (neutral pH etc.), the surface activity should be lost and this risk eliminated. Caution must however be taken to ensure that the degradation products also are harmless to living organisms.

Surfactants have a variety of uses within the well stimulation industry so the lack of a suitable choice of compatible surfactants for well completion, stimulation and/or well intervention jobs in the North Sea has a serious impact.

For example, surfactants can be used to lower the surface and interfacial tensions; thus lowering the capillary forces that restrict the fluid flow in the rock matrix, which enable faster clean up and more complete recovery of the stimulation fluids. Any new environmental friendly surfactant in aqueous solutions expected to be used in stimulation applications should reduce water surface tension from 72 dyne/cm to around 32 to 28 dyne/cm. Current surfactants can lower surface tension down to 30 dyne/cm, but do not result in an acceptable environmental profile, with their toxicity to fish being high, their biodegradation rate being unacceptable or their bioaccumulation being too high.

Furthermore, the surfactant must also be compatible with the other components of a stimulation fluid. More specifically, the surfactant should preferably be non-ionic to prevent any compatibility issues from arising with anionic, species, crosslinkers, delay agents, or formation minerals. Non-ionic surfactants by definition do not contain any functionality having a formal charge. The surface activity results derive from the balance of hydrophobic and hydrophilic structures contained in the surfactant molecule. The shift or alteration of this balance toward more hydrophobic or more hydrophilic influences the surfactant's functional properties to achieve a desired effect. Non-ionic surfactants have attributes that make their use advantageous over other surfactant types. With their lack of charge, non-ionic surfactants are compatible with any other required cationic and anionic surfactants.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In embodiments the present disclosure relates to methods of use of treatment fluids comprising branched alcohol ethoxylated nonionic surfactants. In particular the disclosure also relates to methods of use of treatment fluids comprising environmentally acceptable Guerbet branched alcohol ethoxylated nonionic surfactants.

In embodiments, the present disclosure describes a method of treating a subterranean formation penetrated by a wellbore, the method comprising: introducing a treatment fluid comprised at least a surfactant comprised of at least a branched ethoxylated surfactant to the subterranean formation.

### BRIEF DESCRIPTION OF DRAWINGS

FIG. 1 shows a plot of the viscosity of different surfactants at 104° C. (220° F.) for Examples 2.1-2.3.

FIG. 2 is a rheology profile of Examples 2.4-2.6.

FIG. 3 is a rheology profile of Examples 2.7-2.9.

FIG. 4 is a rheology profile of Examples 3.1-3.4.

FIG. 5 is a rheology profile of Examples 3.5-3.8.

FIG. 6 is a rheology profile of Examples 3.9-3.12.

FIG. 7 is a rheology profile of Examples 4.1-4.4.

FIG. 8 is a rheology profile of Examples 4.5-4.8.

FIG. 9 is a rheology profile of Examples 5.1-5.4.

FIG. 10 is a rheology profile of Examples 5.5-5.8.

FIG. 11 is a rheology profile of Examples 6.1-6.4.

FIG. 12 is a rheology profile of Examples 6.5-6.8.

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation-specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, (1) even if numerous specific data points within the range are explicitly identified, (2) even if reference is made to a few specific data points within the range, or (3) even when no data points within the range are explicitly identified, it is to be understood (i) that the inventors appreciate and understand that any conceivable data point within the range is to be considered to have been specified, and (ii) that the inventors possessed knowledge of the entire range, each conceivable sub-range within the range, and each conceivable point within the range

The present disclosure is generally directed toward the use of wellbore fluids comprising a class of nonionic surfactants which are environmentally friendly, provide low surface and interfacial tension, and are compatible with other stimulation additives, while also maintaining a favorable environmental rating in the North Sea.

As used herein, the term “environmentally friendly” is defined as chemicals or formulations that can pass the most stringent environmental testing criteria. Furthermore, as used herein, the term “environmentally unfriendly” is defined as chemicals or formulations that do not pass the most stringent environmental testing criteria. At present, the geographic location with the most stringent environmental testing criteria for well treatment operation is the North Sea, but the definition of either of these terms should in no way be limited to any past, present or future North Sea environmental testing criteria.

The term “treatment”, or “treating”, refers to any subterranean operation that uses a fluid in conjunction with a desired function and/or for a desired purpose. The term “treatment”, or “treating”, does not imply any particular action by the fluid.

The term “horizontal wellbore” refers to wells that are substantially drilled through a subterranean zone to maximize the exposure to the zone. For zones which are primarily horizontal, the wellbore may have a deviation from the vertical of 80 to 110 degrees in the productive zone of interest. For those zones that have an inclination from the horizontal, the wellbore will primarily be drilled at an angle to keep the wellbore within the zone. Horizontal wellbores are typically vertical near the surface and incline to a direction substantially parallel to the bedding planes of the zone into which the wellbore is placed. Often in shale reservoirs and low permeability formations, multiple hydraulic fractures are placed along the length of this wellbore to maximize contact between the formation and the wellbore. Fractures are normally done starting at the toe of the well and suitable means are employed to isolate those fractures before the next fracture is performed. When all fracturing is complete, the isolation mechanism (often referred to as zonal isolation”) is removed and all the fractured zones are in hydraulic communication with the wellbore and the surface. Zonal isolation systems are used to isolate and selectively produce oil or gas from separate zones in a single well, which are described in detail in U.S. Pat. Nos. 5,579,844; 5,609,204 and 5,988,285, the disclosures of which are incorporated by reference herein in their entirety. For the extended time to fully complete the well with multiple fractures, the first fractures may be shut-in for several days to several weeks, which provide an environment for microbes to flourish if biocides are not included in the treatment fluid. Traditional biocides do not always have the capability to provide protection for extended time needed in these wells.

The term “fracturing” refers to the process and methods of breaking down a geological formation and creating a fracture, i.e., the rock formation around a wellbore, by pumping fluid at a very high pressure (pressure above the determined closure pressure of the formation), in order to increase production rates from or injection rates into a hydrocarbon reservoir. The fracturing methods otherwise use conventional techniques known in the art.

A “crosslinker” or “crosslinking agent” is a compound mixed with a base-gel fluid to create a viscous gel. Under proper conditions, the crosslinker reacts with a water soluble polymer to couple the molecules, creating a crosslinked polymer fluid of high, but closely controlled viscosity.

A “fracturing fluid” is often described as a fluid comprising a linear gel, a crosslinked gel, a viscoelastic surfactant gel, an emulsion or a foamed fluid, or a slickwater. Linear and crosslinked gels typically contain 1.2 to 9.6 kg/cubic meter (10 to 80 pounds per thousand gallons) of a biopolymer such as guar or a derivatized guar. Crosslinked fluids have a higher viscosity from the effect of the crosslinker. Viscoelastic surfactant systems are characterized by developing viscosity by means of the entanglements on substantially elongated micellar systems (worm like micelles) derived from some specific classes of surfactants. Emulsions and foams are characterized by the presence of a separate immiscible phase in addition to the aqueous viscosified fluid, oil for emulsions and gas for foams. Slickwater is characterized as water or brine containing small amounts of a drag reducing agent such as polyacrylamide, a micellar solution of viscoelastic surfactants, or a low concentration linear gel which reduces friction by 40 to 80% over that experienced without the drag reducer. This allows the treatment to be pumped at higher rate or lower pressure. Various other additives comprise the fracturing fluid including biocides, scale inhibitors, surfactants, additional breakers (besides those mentioned above), breaker aids, oxygen scavengers, alcohols, corrosion inhibitors, fluid-loss additives, fibers, proppant flow back additives, thermal stabilizers, proppants and the like.

The term “hydraulic fracturing” as used in the present application refers to a technique that involves pumping fluids into a well at pressures and flow rates high enough to split the rock and create opposing cracks extending up to 300 m (1000 feet) or more from either side of the borehole. Later, sand or ceramic particulates, called “proppant,” are carried by the fluid to pack the fracture, keeping it open once pumping stops and pressure declines. Complex fractures which include secondary and tertiary fractures connecting to the main fracture can also result from fracturing operations and are dependent upon the formation properties.

As used herein, the term “liquid composition” or “liquid medium” refers to a material which is liquid under the conditions of use. For example, a liquid medium may refer to water, a brine, a solution and/or an organic solvent which is above its freezing point and below its boiling point of the material at a particular pressure. A liquid medium may also refer to a supercritical fluid.

As used herein, the term “polymer” or “oligomer” is used interchangeably unless otherwise specified, and both refer to homopolymers, copolymers, interpolymers, terpolymers, and the like. Likewise, a copolymer may refer to a polymer comprising only two monomers, or comprising at least two monomers, optionally with other additional monomers. When a polymer is referred to as comprising a monomer, the monomer is present in the polymer in the polymerized form of the monomer or in the derivative form of the monomer. However, for ease of reference the phrase comprising the (respective) monomer or the like is used as shorthand.

In accordance with the presently claimed subject matter, an “branched alcohol ethoxylated” refers to an organic surface active molecule or compound comprising a functional hydrocarbon structure having an hydrophilic ethylene oxide portion linked to a hydrophobic branched hydrocarbon alcohol portion, with an overall carbon chain length of about 10 to about 60 carbon atoms, such as for, example, from about 10 to about 42, from about 10 to about 36, from about 12 to about 32, from about 14 to about 30 carbon atoms. Furthermore, the ethylene oxide hydrophilic portion of the organic surface active molecule may have an average EO length (with each mole of ethylene oxide comprising 2 carbon atoms, four hydrogen atoms, and one oxygen atom) from about 1 to about 16 moles of ethylene oxide (EO) per mole of alcohol, from about 1 to about 12 moles of ethylene oxide (EO) per mole of alcohol, from about 2 to about 10 moles of ethylene oxide (EO) per mole of alcohol, from about 3 to about 8 moles of ethylene oxide (EO) per mole of alcohol. Where it is understood that the length of the ethylene oxide chain is a distribution of chains with an average polymerization rate which is defined as the average EO length, and wherein the hydrophobic branched hydrocarbon chain portion is branched comprising at least one alkyl group. The alcohol from which the hydrocarbon chain is derived may be mono-substituted. The hydrophobic branched hydrocarbon chain alcohol portion may be derived from a primary alcohol or a secondary alcohol. The hydrophobic branched hydrocarbon chain alcohol portion may be derived from a naturally occurring alcohol or a synthetically manufactured alcohol. The hydrophobic branched hydrocarbon chain alcohol portion may be derived from a saturated alcohol or an unsaturated alcohol. The alcohol may have an average carbon chain length of about 8 to about 36 carbon atoms, or an average carbon chain length of about 8 to about 24 carbon atoms, or an average carbon chain length of about 10 to about 18 carbon atoms, or an average carbon chain length of about 10 to about 16 carbon atoms.

As used herein, the term “non-removable impurities”, refers to byproducts, or unreacted components used in the commercial surfactant synthesis and purification, that cannot be removed from the commercial mixture at an practical and economical rate, and that thus said byproducts, or unreacted components can influence the performance of the commercial surfactant product including but not limited to surface active properties, solubility, environmental and toxicological profile, compatibility and reactivity with stimulations fluids, and rock fluid interactions.

The environmental and toxicological characteristics of a commercially available surfactant (which typically comprises added solvents, added salts, active surfactant molecule, unreacted alcohol, unattached PEO, and other minor impurities) evaluated, by assessing the environmental and toxicological profile of each component of the mixture to the extent that purification is possible. Thus the environmental and toxicological profile of the surfactant reflects that of the active surfactant molecule, in combination with the minor concentration of non-removable impurities that cannot be removed through routine plant operations or even specialized laboratory purifications steps, including unreacted alcohol, unattached PEO, and other minor impurities. Typically the content of unreacted alcohol, unattached PEO, and other minor impurities of a commercially available surfactant product depends on the process followed for its commercial synthesis and purification. Thus the environmental and toxicological profile of the surfactant can be dependent on the process followed to achieve its synthesis. In the foregoing, when referring to the environmental and toxicological profile of a commercial surfactant, it will be understood that this profile will be partially determined by the surfactant structure, but also partially determined by the process followed for its commercial synthesis and purification, since this determines the content of non-removable impurities.

In the foregoing, when describing molecular structures, it will be understood that in the case of polymeric or oligomeric structures or polymer or oligomer containing structures, a single molecular structure may not perfectly describe the chemical in question, since different molecules considered to pertain to the same chemical compound may have different degrees of polymerization. For each individual single molecule the degree of polymerization is defined as an integer number, which corresponds to the number of times a particular structure is repeated. Polymeric or polymer containing chemical products are necessarily mixtures of molecules with different degrees of polymerization, and thus it is understood that while individual molecules will be characterized by integer degree of polymerization values, commercially available products may be found with non-integer degrees of polymerization. Surfactants as disclosed herein can be considered as molecules comprising two different types of polymers or oligomers, the EO structure, and the hydrocarbon structure, linked together through a covalent bond such as an ether bond between the alcohol precursor in the hydrophobic chain, and the ethylene oxide moiety, whereby both EO and the hydrocarbon structure present a distribution on chain lengths each with its respective degree of polymerization. When describing possible structures for the branched alcohol ethoxylated nonionic surfactants disclosed herein, integer values of degree of polymerization will be discussed for specific molecules, but this does not preclude that mixtures of molecules having different degrees of polymerization are considered to pertain to the same structure, and therefore the overall or average degree of polymerization may be a non-integer number.

Branched Alcohol Ethoxylate

In embodiments, the treatment fluid may comprise a branched alcohol ethoxylated surfactant, which is a non-ionic surfactant. Thus, the length and nature of the hydrophobic chain distribution, and the length and nature of the hydrophilic chain distribution can vary depending on the source of hydrophobe, natural or synthetic, the degree of saturation or unsaturation of the hydrophobe, the synthetic method used to obtain the hydrocarbon, and on the polymerization method used to obtain the hydrophilic chain. Also the distribution of lengths of both hydrophobic and hydrophilic chains controls the properties of the surfactants.

A commonly used parameter to compare performance of various non-ionic surfactants is the Hydrophilic-Lipophilic Balance, HLB: Based on the HLB a formulator can identify surfactants manufactured through different processes, which yield different chemical structures, whereby it is expected that surfactants with similar HLBs will have similar properties.

The hydrophilic-lipophilic balance of a surfactant is a measure of the degree to which it is hydrophilic or lipophilic, determined by calculating values for the different regions of the molecule. Griffin's method is a technique for non-ionic surfactants and is characterized in the following manner:

HLB=20*Mₕ/M

where Mₕ is the molecular mass of the hydrophilic portion of the molecule, and M is the molecular mass of the whole molecule, giving a result on a scale of 0 to 20. An HLB value of 0 corresponds to a completely lipophilic/hydrophobic molecule, and a value of 20 corresponds to a completely hydrophilic/lipophobic molecule. The HLB value can be used to predict the surfactant properties of a molecule:
<10: Lipid soluble (water insoluble)
>10: Water soluble (lipid insoluble)
1.5 to 3: anti-foaming agent
3 to 6: W/O (water in oil) emulsifier
7 to 9: wetting and spreading agent
13 to 15: detergent
12 to 16: O/W (oil in water) emulsifier
15 to 18: solubiliser or hydrotrope

The Davies method is another method to calculate the hydrophilic-lipophilic balance of a surfactant, which is based upon on the chemical groups of the molecule. The advantage of this method is that it takes into account the effect of stronger and weaker hydrophilic groups. The method works as follows

$$HLB = 7 + {\sum }_{i = 1}^{m} {H}_{i} - n \times 0.475$$

where: m is the number of hydrophilic groups in the molecule, n is the number of lipophilic groups in the molecule and Hᵢ is the value of the i^{th} hydrophilic groups (see tables below)

| | Group |
|---|---|
| Hydrophilic Groups | Number |
| —SO₄ Na⁺ | 38.7 |
| —COO K⁺ | 21.1 |
| —COO Na⁺ | 9.4 |
| N (tertiary amine) | 9.4 |
| Ester (sorbitan ring) | 6.8 |
| Ester (free) | 2.4 |
| —COOH | 2.1 |
| Hydroxyl (free) | 1.9 |
| —O— | 1.3 |
| Hydroxyl (sorbitan ring) | 0.5 |

| Lipophilic | Group |
|---|---|
| Groups | Number |
| —CH— | −0.475 |
| —CH₂— | −0.475 |
| CH₃— | −0.475 |
| ═CH— | −0.475 |

Applications in wellbore fluids exist where a plurality of HLB surfactants can be required to achieve specific performances, such as wetting, de-wetting, oil-in-water (O/W), and water-in-oil (W/O) emulsification, de-emulsification, foaming, de-foaming, reduction of surface tension, or interfacial tension. While a multitude of surfactants with HLBs providing such performance exist and are commonly used in the industry, there is a need for surfactants with improved environmental profile for use in off-shore applications in environmentally concerned environments.

Some alcohols used to synthesize non-ionic surfactants are isolated from naturally occurring triglycerides (fatty acid triesters), which form the bulk of natural oils and fats, by transesterification to give methyl esters which in turn are hydrogenated to the alcohols. Traditional sources of fatty alcohols for the surfactant industry have largely been various vegetable oils and these remain a large-scale feedstock for linear alcohols. Animal fats (tallow) have also been used in the surfactant industry, particularly whale oil, however they are no longer used on a large scale. Tallows produce a fairly narrow range of alcohols, predominantly C16-C18, the chain lengths from plant sources are more variable (C6-C24) making them the preferred source. Higher alcohols (C20-C22) can be obtained from rapeseed oil or mustard seed oil. Midcut alcohols are obtained from coconut oil (C12-C14) or palm kernel oil (C16-C18). Despite their natural origin, linear alcohol derivatives fail to result in substantially biodegradable, substantially non bioacumulative, and or substantially nontoxic surfactants, making of these products undesirable in environmentally concerned off-shore markets.

As discussed above, the surfactant disclosed herein is a branched alcohol derived surfactant, with acceptable biodegradation, bioaccumulation, and acceptable low toxicity. Furthermore, the “branched alcohol” portion of the surfactant may be naturally obtained, or more commonly synthetically. Branched-chain fatty acids are common constituents of the lipids of bacteria and animals, although they are rarely found in the integral lipids of higher plants. Normally, the fatty acyl chain is saturated and the branch is a methyl-group. Also, unsaturated branched-chain fatty acids are found in marine animals, and branches other than methyl may be present in microbial lipids. The most common branched chain fatty acids are mono-methyl-branched, but di- and poly-methyl-branched fatty acids are also known. Despite branched fatty acid being found in living organisms, their source and relatively low abundance prevents them from being a cost effective source of branched hydrocarbon. Therefore branched hydrocarbon base surfactants are obtained from branched alcohols produced by a number of reaction mechanisms, such as, for example, through isolation and purification of the branched by-products of the hydrocarbon chain synthetic paths yielding substantially linear alcohols such as the ethylene polymerization based processes, including: i) the Ziegler process where ethylene is polymerized using triethylaluminium, followed by oxidation to yield even numbered alcohols (commonly named Ziegler alcohols), or ii) the oxo process (or Shell process), where ethylene polymerization is followed by hydro-formylation (to yield aldehydes which are subsequently reduced by hydrogenation yielding odd numbered alcohols commonly named-Oxo alcohols), and the Fischer-Tropsch synthetic paths which yield chain length distributions that follow the Shultz-Flory distribution, (commonly named Fischer-Tropsch alcohols).

Industrial alcohols synthesized through commonly used processes do not usually yield one chemical isomer but are composed of different chemical alcohol structures with variations in alkyl chain length and alkyl branching. It has been surprisingly found that branched alcohols obtained through a dimerization process yielding monodispersed chain distributions of branched alcohols, the Guerbet reaction, can yield upon ethoxylation, surfactants with improved biodegradation, bioaccumulation, and lower toxicity, but yet provide appropriate compatibility with stimulation fluids. These branched alcohol are sometimes referred to as “Guerbet alcohols”, and the surfactants derived therefrom can be referred to as “Guerbet surfactants”.

In embodiments, the branched alcohol surfactant may have the structure of Formula 1:

CH₃—[CH₂]ₐ—CH{[CH₂]_{b}—CH₃}—[CH₂]_{c}—[—O—CH₂—CH₂—]ₓ—OH, (1)

where a, b, and c are integers that are each greater than or equal to 0, where a≤y−3, b≤y−3, c≤y−3, where y is an integer greater than or equal to 6 and less than or equal to 36, y being defined as the sum of the integer 3 and a, b and c (y=a+b+c+3) and x is an integer of from about 1 to about 12.

In embodiments, the branched alcohol surfactant may have the structure of Formula 2:

CH₃—[CH₂]_{d}—CH{[CH₂]ₑ—CH₃}—CH₂—[—O—CH₂—CH₂-]ₓ-OH, (2)

where d and e are integers that are each greater than or equal to 0, where d≤z−4, e≤z−4, where z is an integer greater than or equal to 6 and less than or equal to 36, z being defined as the sum of the integer 4 and e, d and c (z=d+e+4) and x is an integer of from about 1 to about 12.

In embodiments, the branched alcohol surfactant may have the structure of Formula 3:

CH₃—[CH₂]_{f}—[CH₂]₂—CH{[CH₂]_{f}—CH₃}—CH₂—[—O—CH₂—CH₂-]ₓ-OH, (3)

where f is an integer and is greater than or equal to 1 and x is an integer of from about 1 to about 12.

The design of fracturing treatments is described in U.S. Pat. No. 7,337,839, which is incorporated herein by reference in its entirety. Although the present disclosure describes the use of the branched alcohol ethoxylated surfactant in fracturing treatments, it can also be used in other treatments.

The branched alcohol ethoxylated surfactant may initially be in a solid, waxy, or liquid form. When in a solid form, the branched alcohol ethoxylated surfactant may be crystalline or granular materials. Both the liquid, the waxy and the solid form may be encapsulated or provided with a coating to delay its release into the treatment fluid. Encapsulating materials and methods of encapsulating breaking materials are known in the art. Non-limiting examples of materials and methods that may be used for encapsulation are described, for instance, in U.S. Pat. Nos. 4,741,401; 4,919,209; 6,162,766 and 6,357,527, the disclosures of which are incorporated herein by reference in their entireties. Methods to encapsulate liquids are also available to the industry.

When used as a liquid or fluid, the branched alcohol ethoxylated surfactant is commonly dissolved or dispersed in an aqueous solution.

The branched alcohol ethoxylated surfactant may be added to a viscosified or unviscosified treatment fluid before this fluid is introduced into the well bore, or the branched alcohol ethoxylated surfactant may be added as a separate fluid, such as an aqueous or organic based fluid, that is introduced into the wellbore after at least a portion or the entire amount of a viscosified or unviscosified treatment fluid has been introduced into the wellbore.

The amount of the branched alcohol ethoxylated surfactant present in the viscosified or unviscosified treatment fluid (or aqueous or organic based fluid) may depend on several factors including the branched alcohol ethoxylated surfactant selected, the amount and ratio of the other components in the viscosified or unviscosified treatment fluid (or aqueous or organic based fluid), the required performance, the desired contact angle, or surface tension or interfacial tension reduction expected, the contacting time desired, the temperature, pH, and ionic strength of the viscosified or unviscosified treatment fluid (or aqueous or organic based fluid).

In embodiments wherein the branched alcohol ethoxylated surfactant is introduced in a fluid separate from the viscosified or unviscosified fluid, the branched alcohol ethoxylated surfactant may be incorporated into an aqueous or organic based fluid in which the branched alcohol ethoxylated surfactant may present in an amount above about 0.001% by weight of the aqueous or organic based fluid, such as in an amount from about 0.002% to about 2% by weight of aqueous or organic based fluid, in an amount from 0.01% to about 0.6% by weight of aqueous or organic based fluid, in an amount from 0.04% to about 0.35% by weight of aqueous or organic based fluid, in an amount from about 0.06% to about 0.3% by weight of the aqueous or organic based fluid, or in an amount from about 0.09% to about 0.25% by weight of the aqueous or organic based fluid.

The branched alcohol ethoxylated surfactant may be present in the viscosified or unviscosified fluid (added before introducing the viscosified or unviscosified treatment fluid into the wellbore) in an amount above about 0.001% by weight of the viscosified or unviscosified fluid, such as in an amount from about 0.002% to about 2% by weight of the viscosified or unviscosified fluid, in an amount from 0.01% to about 0.6% by weight of the viscosified or unviscosified fluid, in an amount from about 0.04% to about 0.35% by weight of the viscosified or unviscosified fluid, or in an amount from about 0.06% to about 0.3% by weight of the viscosified or unviscosified fluid, or in an amount from about 0.09% to about 0.25% by weight of the viscosified or unviscosified fluid. In such embodiments, the concentration ratio of the branched alcohol ethoxylated surfactant to the polymeric material (branched alcohol ethoxylated: polymeric material) in the viscosified or unviscosified fluids may be in a range of from about 1:100 to about 100:1, such as a concentration ratio in range of from about 1:50 to about 50:1, a concentration ratio in range of from about 1:10 to about 10:1, or a concentration ratio in range of from about 1:3 to about 3:1.

As used herein, the phrases “viscosified fluid,” “viscosified treatment fluid” or “viscosified fluid for treatment” (hereinafter generally referred to as a “viscosified fluid” unless specified otherwise) mean, for example, a composition comprising a solvent, a viscosifying material, such as a polymeric material, which may include any crosslinkable compound and/or substance with a crosslinkable moiety (hereinafter “crosslinkable component”). The viscosified fluids of the present disclosure may be substantially inert to any produced fluids (gases and liquids) and other fluids injected into the wellbore or around the wellbore.

In embodiments, an alkyl polyglucoside surfactant with improved environmental profile is disclosed.

The polymers present in the viscosified fluid may be those commonly used with fracturing fluids. The polymers may be used in either crosslinked or non-crosslinked form. The polymers may be capable of being crosslinked with any suitable crosslinking agent, such as metal ion crosslinking agents. Examples of such materials include the polyvalent metal ions of boron, aluminum, antimony, zirconium, titanium, chromium, etc., that react with the polymers to form a composition with adequate and targeted viscosity properties for various operations. The crosslinking agent may be added in an amount that results in suitable viscosity and stability of the gel at the temperature of use. Crosslinkers may be added at concentrations of about 5 to about 500 parts per million (ppm) of active atomic weight. That concentration may be adjusted based on the polymer concentration.

The crosslinker may be added as a solution and may include a ligand which delays the crosslinking reaction. This delay may be beneficial in that the high viscosity fracturing fluid is not formed until near the bottom of the wellbore to minimize frictional pressure losses and may prevent irreversible shear degradation of the gel, such as when Zr or Ti crosslinking agents are used. Delayed crosslinking may be time, temperature or both time and temperature controlled to facilitate a successful fracturing process.

The polymers and amount used in the viscosified fluid may provide a fluid viscosity (from about 1 cP to about 100,000 cP at the treating temperature) that is sufficient to generate fracture width and facilitate transport and prevention of undue settling of the proppant within the fracture during fracture propagation. Generally, the polymer concentration is reduced to avoid proppant pack damage and maintain sufficient viscosity for opening the fracture and transporting proppant. In embodiments, the concentration of polymer may be selected to facilitate a primary goal of higher proppant loading in the fracture.

In embodiments, the viscosified fluids of the present disclosure may also be prepared from a fluid with crosslinkable components initially having a very low viscosity that can be readily pumped or otherwise handled and that are subsequently crosslinked, such as once it is downhole, to form the viscosified fluid. For example, the viscosity of the initial fluid with crosslinkable components may be from about 1 cP to about 10,000 cP, or be from about 1 cP to about 1,000 cP, or be from about 1 cP to about 100 cP at the treating temperature, which may range from a surface temperature to a bottom-hole static (reservoir) temperature.

Crosslinking the unviscosified fluid with crosslinkable components generally increases its viscosity. As such, having the fluid in the unviscosified state allows for pumping of a relatively less viscous fluid having relatively low friction pressures within the well tubing, and the crosslinking may be delayed in a controllable manner such that the properties of viscosified fluid are available at the rock face instead of within the wellbore. Such a transition to a viscosified fluid state may be achieved over a period of minutes or hours based on the molecular make-up of the crosslinkable components, and results in the initial viscosity of the crosslinkable fluid increasing by at least an order of magnitude, such as at least two orders of magnitude. In embodiments, after the viscosity of the fluid has increased by at least an order of magnitude, such as at least two orders of magnitude, the action of a breaker compound may decrease the viscosity of the viscosified fluid by at least an order of magnitude (for example, reducing the viscosity from about 1,000 centipoise at 100 sec⁻¹ at the treating temperature to about 100 centipoise at 100 sec⁻¹ at the treating temperature) such as at least two orders of magnitude at the treating temperature, or to a viscosity below that of the initial unviscosified fluid (for example from about 10,000 centipoise at 100 sec⁻¹ at the treating temperature to about 100 centipoise at 100 sec⁻¹ at the treating temperature). The disclosed surfactant can enhance, or impair the breaking effect of the breaker compound. The unviscosified fluids or compositions suitable in the methods of the present disclosure may comprise a crosslinkable component. As discussed above, a “crosslinkable component,” as the term is used herein, is a compound and/or substance that comprises a crosslinkable moiety capable of being crosslinked by a crosslinking agent. Suitable crosslinking agents for the methods of the present disclosure would be capable of crosslinking polymer molecules to form a three-dimensional network. Suitable inorganic crosslinking agents include, but are not limited to, polyvalent metals, conventional chelated polyvalent metals, and compounds capable of yielding polyvalent metals. Also suitable organic crosslinkers, including but not limited to functional reactive components such as dialdehydes like glyoxal, and the like can be used as crosslinking agents. The concentration of the cross linking agent in the crosslinkable fluid may be from about 0.001 wt. % to about 10 wt. %, such as about 0.005 wt. % to about 2 wt. %, or about 0.01 wt. % to about 1 wt. %.

The crosslinkable component may be natural or synthetic polymers (or derivatives thereof) that comprise a crosslinkable moiety, for example, substituted galactomannans, guar gums, high-molecular weight polysaccharides composed of mannose and galactose sugars, or guar derivatives, such as hydrophobically modified guars, guar-containing compounds, and synthetic polymers. Suitable crosslinkable components may comprise a guar gum, a locust bean gum, a tara gum, a honey locust gum, a tamarind gum, a karaya gum, an arabic gum, a ghatti gum, a tragacanth gum, a carrageenen, a succinoglycan, a xanthan, a diutan, a hydroxylethylguar hydroxypropyl guar, a carboxymethylhydroxyethyl guar, a carboxymethylhydroxypropylguar, an alkylcarboxyalkyl cellulose, an alkyl cellulose, an alkylhydroxyalkyl cellulose, a carboxyalkyl cellulose ether, a hydroxyethylcellulose, a carboxymethylhydroxyethyl cellulose, a carboxymethyl starch, a copolymer of 2-acrylamido-2methyl-propane sulfonic acid and acrylamide, a terpolymer of 2-acrylamido-2methyl-propane sulfonic acid, acrylic acid, acrylamide, or derivatives thereof. In embodiments, the crosslinkable components may present at about 0.01% to about 4.0% by weight based on the total weight of the crosslinkable fluid, such as at about 0.10% to about 2.0% by weight based on the total weight of the crosslinkable fluid.

Suitable solvents for use with the unviscosified fluid, viscosified fluid, and/or the environmental surfactant may be aqueous or organic based and mixtures thereof. In embodiments, the surfactant may be introduced into the subterranean formation in a fluid (aqueous or organic) that is separate from the unviscosified fluid or viscosified fluid. In embodiments, the surfactant may be introduced into the subterranean formation after being mixed into either an unviscosified fluid or a viscosified fluid. Aqueous solvents may include at least one of fresh water, sea water, brine, heavy brine, mixtures of water and water-soluble organic compounds and mixtures thereof. Organic solvents may include methanol, isopropanol, ethylene glycol, ethylene glycol monomethyl ether, ethylene glycol dimethyl ether, ethylene glycol monoethyl ether, ethylene glycol monopropyl ether, ethylene glycol monobutyl ether, diethylene glycol monomethyl ether, diethylene glycol dimethyl ether, diethylene glycol monoethyl ether, diethylene glycol monopropyl ether, diethylene glycol monobutyl ether, any organic solvent which is able to dissolve or suspend the various components of the crosslinkable fluid.

In embodiments, the solvent, such as an aqueous solvent, may represent up to about 99.9 weight percent of the unviscosified or viscosified fluid, such as in the range of from about 85 to about 99.9 weight percent of the viscosified fluid, or from about 98 to about 99.7 weight percent of the viscosified fluid.

The viscosified or unviscosified treatment fluids of the present disclosure may be compatible with the environmentally acceptable surfactant of the present disclosure, whereby compatibility is evaluated as the change of the viscosity of the viscosified fluid comprising the environmentally acceptable surfactant of the present disclosure over the viscosity of the viscosified fluid not comprising the environmentally acceptable surfactant of the present disclosure. Acceptable compatibility is considered when the change of viscosity is between 50% and 150% of the viscosity of the viscosified fluid not comprising the environmentally acceptable surfactant of the present disclosure.

While the viscosified fluids or viscosified treatment fluids of the present disclosure are described herein as comprising the above-mentioned components, it should be understood that the fluids of the present disclosure may optionally comprise other chemically different materials. In embodiments, the unviscosified and/or viscosified fluids of the present disclosure may further comprise stabilizing agents, surfactants, diverting agents, or other additives. Additionally, the unviscosified and/or viscosified fluids may comprise a mixture of various crosslinking agents, and/or other additives, such as fibers or fillers, provided that the other components chosen for the mixture are compatible with the intended application. In embodiments, the unviscosified and/or viscosified fluids of the present disclosure may further comprise one or more components selected from the group consisting of a conventional gel breaker, a buffer, a proppant, a clay stabilizer, a gel stabilizer and a surfactant. Furthermore, the unviscosified and/or viscosified fluids may comprise buffers, pH control agents, and various other additives added to promote the stability or the functionality of the fluid. The unviscosified and/or viscosified fluids may be based on an aqueous or non-aqueous solution. The components of the unviscosified and/or viscosified fluids may be selected such that they may or may not react with the subterranean formation that is to be stimulated or treated.

In this regard, the unviscosified and/or viscosified fluids may include components independently selected from any solids, liquids, gases, and combinations thereof, such as slurries, gas-saturated or non-gas-saturated liquids, mixtures of two or more miscible or immiscible liquids, and the like, as long as such additional components allow for the breakdown of the three dimensional structure upon substantial completion of the treatment. For example, the unviscosified and/or viscosified fluids may comprise organic chemicals, inorganic chemicals, and any combinations thereof. Organic chemicals may be monomeric, oligomeric, polymeric, crosslinked, and combinations, while polymers may be thermoplastic, thermosetting, moisture setting, elastomeric, and the like. Inorganic chemicals may be metals, alkaline and alkaline earth chemicals, minerals, and the like. Fibrous materials may also be included in the crosslinkable fluid or treatment fluid. Suitable fibrous materials may be woven or nonwoven, and may be comprised of organic fibers, inorganic fibers, mixtures thereof and combinations thereof.

Stabilizing agents can be added to slow the degradation of the crosslinked structure of the viscosified fluid after its formation downhole. Stabilizing agents may include buffering agents, such as agents capable of buffering at pH of about 8.0 or greater (such as water-soluble bicarbonate salts, carbonate salts, phosphate salts, or mixtures thereof, among others); and chelating agents (such as ethylenediaminetetraacetic acid (EDTA), nitrilotriacetic acid (NTA), or diethylenetriaminepentaacetic acid (DTPA), hydroxyethylethylenediaminetriacetic acid (HEDTA), or hydroxyethyliminodiacetic acid (HEIDA), among others), which may or may not be the same as used for the coordinated ligand system of the chelated metal of the spread crosslinker. Buffering agents may be added to the crosslinkable fluid or treatment fluid in an amount from about 0.05 wt. % to about 10 wt. %, and from about 0.1 wt. % to about 2 wt. %, based upon the total weight of the unviscosified and/or viscosified fluids. Chelating agents may also be added to the unviscosified and/or viscosified fluids.

The aqueous base fluids of the fluids of the present application may generally comprise fresh water, salt water, sea water, a brine (e.g., a saturated salt water or formation brine), or a combination thereof. Other water sources may be used, including those comprising monovalent, divalent, or trivalent cations (e.g., magnesium, calcium, zinc, or iron) and, where used, may be of any density, also commonly known as weight.

The aqueous base fluids of the fluids of the present application may generally comprise i) fresh water, ii) inorganic acids such as hydrochloric acid, hydrofluoric acid, hydrobromic acid, hydroiodic acid, hydrogen sulfide, nitric acid, sulfuric acid, phosphoric acid, carbonic acid, and the like, or iii) organic acids such as methane sulfonic acid, formic acid, acetic acid, lactic acid, glycolic acid, erythorbic acid, citric acid, and the like, and iv) soluble or insoluble salts thereof such as those obtained by neutralization of inorganic acids with alkali metal hydroxydes, such as sodium, potassium, rubidium, or cesium, and the like, namely sodium chloride, sodium fluoride, sodium bromide, sodium iodide, sodium nitrate, sodium sulfate, sodium bisulfate, sodium sulfide, sodium carbonate, sodium hydrogen carbonate, or sodium bicarbonate, sodium hydrogen phosphate, sodium dihydrogen phosphate, or sodium phosphate, and the like; potassium chloride, potassium fluoride, potassium bromide, potassium iodide, potassium nitrate, potassium sulfate, potassium bisulfate, potassium sulfide, potassium carbonate, potassium hydrogen carbonate, or potassium bicarbonate, potassium hydrogen phosphate, potassium dihydrogen phosphate, or potassium phosphate, and the like; rubidium chloride, rubidium fluoride, rubidium bromide, rubidium iodide, rubidium nitrate, rubidium sulfate, rubidium bisulfate, rubidium sulfide, rubidium carbonate, rubidium hydrogen carbonate, or rubidium bicarbonate, rubidium hydrogen phosphate, rubidium dihydrogen phosphate, or rubidium phosphate, and the like; cesium chloride, cesium fluoride, cesium bromide, cesium iodide, cesium nitrate, cesium sulfate, cesium bisulfate, cesium sulfide, cesium carbonate, cesium hydrogen carbonate, or cesium bicarbonate, cesium hydrogen phosphate, cesium dihydrogen phosphate, or cesium phosphate, and the like; or v) soluble or insoluble salts thereof such as those obtained by neutralization of inorganic acids with alkali earth hydroxides, such as magnesium, calcium, strontium, or barium, and the like magnesium chloride, magnesium fluoride, magnesium bromide, magnesium iodide, magnesium nitrate, magnesium sulfate, magnesium sulfide, or magnesium phosphate, magnesium carbonate, magnesium bicarbonate and the like; calcium chloride, calcium fluoride, calcium bromide, calcium iodide, calcium nitrate, calcium sulfate, calcium sulfide, or calcium phosphate, calcium carbonate, calcium bicarbonate and the like; strontium chloride, strontium fluoride, strontium bromide, strontium iodide, strontium nitrate, strontium sulfate, strontium sulfide, or strontium phosphate, strontium carbonate, strontium bicarbonate and the like; barium chloride, barium fluoride, barium bromide, barium iodide, barium nitrate, barium sulfate, barium sulfide, or barium phosphate, barium carbonate, barium bicarbonate and the like; or v) soluble or insoluble salts thereof such as those obtained by neutralization of organic acids with alkali earth metal hydroxydes, such as sodium, potassium, rubidium, or cesium, such as sodium methane sulfonate, sodium formate, sodium acetate, sodium lactate, sodium glycolate, sodium erythorbate, sodium citrate, and the like; such as sodium methane sulfonate, sodium formate, sodium acetate, sodium lactate, sodium glycolate, sodium erythorbate, sodium citrate, and the like; such as potassium methane sulfonate, potassium formate, potassium acetate, potassium lactate, potassium glycolate, potassium erythorbate, potassium citrate, and the like; such as rubidium methane sulfonate, rubidium formate, rubidium acetate, rubidium lactate, rubidium glycolate, rubidium erythorbate, rubidium citrate, and the like; such as cesium methane sulfonate, cesium formate, cesium acetate, cesium lactate, cesium glycolate, cesium erythorbate, cesium citrate, and the like; or v) soluble or insoluble salts thereof such as those obtained by neutralization of organic acids with alkali metal hydroxydes, such as magnesium, calcium, strontium, or barium, and the like; such as magesium methane sulfonate, magesium formate, magesium acetate, magesium lactate, magnesium glycolate, magesium erythorbate, magesium citrate, and the like; such as calcium methane sulfonate, calcium formate, calcium acetate, calcium lactate, calcium glycolate, calcium erythorbate, calcium citrate, and the like; such as strontium methane sulfonate, strontium formate, strontium acetate, strontium lactate, strontium glycolate, strontium erythorbate, strontium citrate, and the like; such as barium methane sulfonate, barium formate, barium acetate, barium lactate, barium glycolate, barium erythorbate, barium citrate, and the like, aluminum, iron, salts, or a combination thereof. Other water sources may be used, including those comprising monovalent, divalent, or trivalent cations (e.g., chromium, titanium, boron, aluminum, zinc, or iron) and, where used, may be of any concentration, density, or weight.

Chelation is the formation or presence of two or more separate bindings between a multiple-bonded ligand and a single multivalent central atom or ion. These ligands may be organic compounds, and are called chelating agents, chelants, or chelators. A chelating agent forms complex molecules with certain metal ions, inactivating the ions so that they cannot normally react with other elements or ions to produce precipitates or scale. Example of chelating agents include nitrilotriacetic acid (NTA); citric acid; ascorbic acid; hydroxyethylethylenediaminetriacetic acid (HEDTA) and its salts, including sodium, potassium, and ammonium salts; ethylenediaminetetraacetic acid (EDTA) and its salts, including sodium, potassium, and ammonium salts; diethylenetriaminepentaacetic acid (DTPA) and its salts, including sodium, potassium, and ammonium salts; phosphinopolyacrylate; thioglycolates; and a combination thereof. Other chelating agent are: aminopolycarboxylic acids and phosphonic acids and sodium, potassium and ammonium salts thereof; HEIDA (hydroxyethyliminodiacetic acid); other aminopolycarboxylic acid members, including already EDTA and NTA (nitrilotriacetic acid), but also: DTPA (diethylenetriamine-pentaacetic acid), and CDTA (cyclohexylenediamintetraacetic acid) are also suitable; phosphonic acids and their salts, including ATMP (aminotri-(methylenephosphonic acid)), HEDP (1-hydroxyethylidene-1,1-phosphonic acid), HDTMPA (hexamethylenediaminetetra-(methylenephosphonic acid)), DTPMPA (diethylenediaminepenta-(methylenephosphonic acid)), and 2-phosphonobutane-1,2,4-tricarboxylic acid.

Aqueous fluid embodiments may also comprise an organoamino compound. Examples of suitable organoamino compounds may include tetraethylenepentamine (TEPA), triethylenetetramine (TETA), pentaethylenehexamine, triethanolamine (PEHA), and the like, or any mixtures thereof. When organoamino compounds are used in fluids described herein, they are incorporated at an amount from about 0.01 wt. % to about 2.0 wt. % based on total liquid phase weight. The organoamino compound may be incorporated in an amount from about 0.05 wt. % to about 1.0 wt. % based on total weight of the fluid.

Thermal stabilizers may also be included in the viscosified or unviscosified fluids. Examples of thermal stabilizers include, for example, methanol, alkali metal thiosulfate, such as sodium thiosulfate, and ammonium thiosulfate, phenothiazine, antioxidizers such as Irganox, or Irgafox, or substituted phenols and polyphenols, like hydroquinone, diterbutyl phenol, tannic acid, and derivatives, and the like. The concentration of thermal stabilizer in the fluid may be from about 0.1 to about 5 weight %, from about 0.2 to about 2 weight %, from about 0.2 to about 1 weight %, from about 0.5 to about 1 weight % of the thermal stabilizers based on the total weight of the fracturing fluid.

One or more clay stabilizers may also be included in the viscosified or unviscosified fluids. Suitable examples include hydrochloric acid and chloride salts, such as, tetramethylammonium chloride (TMAC), chloline chloride, choline carbonate, choline bicarbonate, sodium chloride, or potassium chloride, oligomeric cationic clay stabilizers, or amine containing oligomeric clay stabilizers. Aqueous solutions comprising clay stabilizers may comprise, for example, 0.05 to 0.5 weight % of the stabilizer, based on the combined weight of the aqueous liquid and the organic polymer (i.e., the base gel).

The methods of the present disclosure may also employ an additional surfactant in addition to the branched alcohol ethoxylated surfactant described above. The additional surfactants may also be added to promote dispersion or emulsification of components of the unviscosified and/or viscosified fluids, or to provide foaming of the crosslinked component upon its formation downhole. Suitable surfactants include alkyl polyglucosides, alkyl polyethylene oxide sulfates, alkyl alkylolamine sulfates, modified ether alcohol sulfate sodium salts, or sodium lauryl sulfate, among others. Any surfactant which aids the dispersion and/or stabilization of a gas component in the fluid to form an energized fluid can be used. Viscoelastic surfactants, such as those described in U.S. Pat. Nos. 6,703,352; 6,239,183; 6,506,710; 7,303,018 and 6,482,866, the disclosures of which are incorporated herein by reference in their entireties, are also suitable for use in fluids in some embodiments. Examples of suitable surfactants also include, but are not limited to, amphoteric surfactants or zwitterionic surfactants. Alkyl betaines, alkyl amido betaines, alkyl imidazolines, alkyl amine oxides and alkyl quaternary ammonium carboxylates are some examples of zwitterionic surfactants. An example of a useful surfactant is the amphoteric alkyl amine contained in the surfactant solution AQUAT 944 (available from Baker Petrolite of Sugar Land, Tex.). A surfactant may be added to the crosslinkable fluid in an amount in the range of about 0.01 wt. % to about 10 wt. %, such as about 0.1 wt. % to about 2 wt. %.

Charge screening surfactants may be employed. In some embodiments, the anionic surfactants such as alkyl carboxylates, alkyl ether carboxylates, alkyl sulfates, alkyl ether sulfates, alkyl sulfonates, α-olefin sulfonates, alkyl ether sulfates, alkyl phosphates and alkyl ether phosphates may be used. Anionic surfactants have a negatively charged moiety and a hydrophobic or aliphatic tail, and can be used to charge screen cationic polymers. Examples of suitable ionic surfactants also include, but are not limited to, cationic surfactants such as alkyl amines, alkyl diamines, alkyl ether amines, alkyl quaternary ammonium, dialkyl quaternary ammonium and ester quaternary ammonium compounds. Cationic surfactants have a positively charged moiety and a hydrophobic or aliphatic tail, and can be used to charge screen anionic polymers such as CMHPG.

In other embodiments, the surfactant may be a blend of two or more of the surfactants described above, or a blend of any of the surfactant or surfactants described above with one or more nonionic surfactants. Examples of suitable nonionic surfactants include, but are not limited to, alkyl alcohol ethoxylates, alkyl phenol ethoxylates, alkyl acid ethoxylates, alkyl amine ethoxylates, sorbitan alkanoates and ethoxylated sorbitan alkanoates. Any effective amount of surfactant or blend of surfactants may be used in aqueous energized fluids.

The viscosifying agent may be a viscoelastic surfactant (VES). The VES may be selected from the group consisting of cationic, anionic, zwitterionic, amphoteric, nonionicand combinations thereof. Some non-limiting examples are those cited in U.S. Pat. No. 6,435,277 (Qu et al.) and U.S. Pat. No. 6,703,352 (Dahayanake et al.), each of which are incorporated herein by reference in their entirety. The viscoelastic surfactants, when used alone or in combination, are capable of forming micelles that form a structure in an aqueous environment that contribute to the increased viscosity of the fluid (also referred to as “viscosifying micelles”). These fluids are normally prepared by mixing in appropriate amounts of VES suitable to achieve the desired viscosity. The viscosity of VES fluids may be attributed to the three dimensional structure formed by the components in the fluids. When the concentration of surfactants in a viscoelastic fluid significantly exceeds a critical concentration, and in most cases in the presence of an electrolyte, surfactant molecules aggregate into species such as micelles, which can interact to form a network exhibiting viscous and elastic behavior.

In general, particularly suitable zwitterionic surfactants have the formula:

RCONH—(CH₂)ₖ(CH₂CH₂O)ₗ(CH2)ₘ—N⁺(CH₃)₂—(CH2)_{k′}(CH2CH2O)_{l′}(CH2)_{m′}COO⁻

in which R is an alkyl group that contains from about 11 to about 23 carbon atoms which may be branched or straight chained and which may be saturated or unsaturated; k, l, k′, and l′ are each from 0 to 10 and m and m′ are each from 0 to 13; k and l are each 1 or 2 if m is not 0 and (k+1) is from 2 to 10 if m is 0; k′ and l′ are each 1 or 2 when m′ is not 0 and (k′+1′) is from 1 to 5 if m is 0; (m+m′) is from 0 to 14; and CH2CH2O may also be OCH2CH2. In some embodiments, a zwitterionic surfactants of the family of betaine may be used.

Exemplary cationic viscoelastic surfactants include the amine salts and quaternary amine salts disclosed in U.S. Pat. Nos. 5,979,557, and 6,435,277 which are hereby incorporated by reference in their entirety. Examples of suitable cationic viscoelastic surfactants include cationic surfactants having the structure: R1N⁺(R2)(R3)(R4)X⁻

which R1 has from about 14 to about 26 carbon atoms and may be branched or straight chained, aromatic, saturated or unsaturated, and may contain a carbonyl, an amide, a retroamide, an imide, a urea, or an amine; R2, R3, and R4 are each independently hydrogen or a C1 to about C6 aliphatic group which may be the same or different, branched or straight chained, saturated or unsaturated and one or more than one of which may be substituted with a group that renders the R2, R3, and R4 group more hydrophilic; the R2, R3 and R4 groups may be incorporated into a heterocyclic 5- or 6-member ring structure which includes the nitrogen atom; the R2, R3 and R4 groups may be the same or different; R1, R2, R3 and/or R4 may contain one or more ethylene oxide and/or propylene oxide units; and X is an anion. Mixtures of such compounds are also suitable. As a further example, R1 is
from about 18 to about 22 carbon atoms and may contain a carbonyl, an amide, or an amine, and R2, R3, and R4 are the same as one another and contain from 1 to about 3 carbon atoms.

Amphoteric viscoelastic surfactants are also suitable. Exemplary amphoteric viscoelastic surfactant systems include those described in U.S. Pat. No. 6,703,352, for example amine oxides. Other exemplary viscoelastic surfactant systems include those described in U.S. Pat. Nos. 6,239,183; 6,506,710; 7,060,661; 7,303,018; and 7,510,009 for example amidoamine oxides. These references are hereby incorporated by reference in their entirety. Mixtures of zwitterionic surfactants and amphoteric surfactants are suitable. An example is a mixture of about 13% isopropanol, about 5% 1-butanol, about 15% ethylene glycol monobutyl ether, about 4% sodium chloride, about 30% water, about 30% cocoamidopropyl betaine, and about 2% cocoamidopropylamine oxide.

The viscoelastic surfactant system may also be based upon any suitable anionic surfactant. In some embodiments, the anionic surfactant is an alkyl sarcosinate. The alkyl sarcosinate can generally have any number of carbon atoms. Alkyl sarcosinates can have about 12 to about 24 carbon atoms. The alkyl sarcosinate can have about 14 to about 18 carbon atoms. Specific examples of the number of carbon atoms include 12, 14, 16, 18, 20, 22, and 24 carbon atoms. The anionic surfactant is represented by the chemical formula: R1CON(R2)CH2X, wherein R1 is a hydrophobic chain having about 12 to about 24 carbon atoms, R2 is hydrogen, methyl, ethyl, propyl, or butyl, and X is carboxyl or sulfonyl. The hydrophobic chain can be an alkyl group, an alkenyl group, an alkylarylalkyl group, or an alkoxyalkyl group. Specific examples of the hydrophobic chain include a tetradecyl group, a hexadecyl group, an octadecenyl group, an octadecyl group, and a docosenoic group.

Friction reducers may also be incorporated in any fluid embodiment. Any suitable friction reducer polymer, such as polyacrylamide and copolymers, partially hydrolyzed polyacrylamide, poly(2-acrylamido-2-methyl-1-propane sulfonic acid) (polyAMPS), and polyethylene oxide may be used. Commercial drag reducing chemicals such as those sold by Conoco Inc. under the trademark “CDR” as described in U.S. Pat. No. 3,692,676 or drag reducers such as those sold by Chemlink designated under the trademarks FLO1003, FLO1004, FLO1005 and FLO1008 have also been found to be effective. These polymeric species added as friction reducers or viscosity index improvers may also act as excellent fluid loss additives reducing the use of conventional fluid loss additives. Latex resins or polymer emulsions may be incorporated as fluid loss additives. Shear recovery agents may also be used in embodiments.

Diverting agents may be added to improve penetration of the unviscosified and/or viscosified fluids into lower-permeability areas when treating a zone with heterogeneous permeability.

The viscosified fluid for treating a subterranean formation of the present disclosure may be a fluid that has a viscosity of above about 50 centipoise at 100 sec⁻¹, such as a viscosity of above about 100 centipoise at 100 sec⁻¹ at the treating temperature, which may range from about 79.4° C. (175° F.) to about 232.2° C. (450° F.), such as from about 79.4° C. (175° F.) to about 121° C. (250° F.), from about 93.3° C. (200° F.) to about 121° C. (250° F.), or from about 93.3° C. (200° F.) to about 107° C. (225° F.), or from about 93.3° C. (200° F.) to about 1048.9° C. (300° F.), or from about 121° C. (250° F.) to about 176.7° C. (350° F.), or from about 148.9° C. (300° F.) to about 232.2° C. (450° F.). In embodiments, the crosslinked structure formed that is acted upon by disclosed surfactant may be a gel that is substantially non-rigid after substantial crosslinking. In some embodiments, a crosslinked structure that is acted upon by the disclosed surfactant is a non-rigid gel. Non-rigidity can be determined by any techniques known to those of ordinary skill in the art. The storage modulus G′ of substantially crosslinked fluid system of the present disclosure, as measured according to standard protocols given in U.S. Pat. No. 6,011,075, the disclosure of which is hereby incorporated by reference in its entirety, may be about 150 dynes/cm² to about 500,000 dynes/cm², such as from about 1000 dynes/cm² to about 200,000 dynes/cm², or from about 10,000 dynes/cm² to about 150,000 dynes/cm².

The methods of the present disclosure may also employ a breaker. In this regard, conventional oxidizers, enzymes, or acids may be used. Such breakers reduce the polymer's molecular weight by the action of an acid, an oxidizer, an enzyme, or some combination of these on the polymer itself. In the case of borate-crosslinked gels, increasing the pH and therefore increasing the effective concentration of the active crosslinker, the borate anion, reversibly create the borate crosslinks. Lowering the pH can just as easily remove the borate/polymer bonds. At a high pH above 8, the borate ion exists and is available to crosslink and cause gelling. At lower pH, the borate is tied up by hydrogen and is not available for crosslinking, thus gelation by borate ion is reversible.

Embodiments may also include proppant particles that are substantially insoluble in the fluids of the formation. Proppant particles carried by the unviscosified and/or viscosified fluids remain in the fracture created, thus propping open the fracture when the fracturing pressure is released and the well is put into production. Suitable proppant materials include, but are not limited to, sand, walnut shells, sintered bauxite, glass beads, ceramic materials, naturally occurring materials, or similar materials. Mixtures of proppants can be used as well. If sand is used, it may be from about 20 to about 100 U.S. Standard Mesh in size. With synthetic proppants, mesh sizes about 8 or greater may be used. Naturally occurring materials may be underived and/or unprocessed naturally occurring materials, as well as materials based on naturally occurring materials that have been processed and/or derived. Suitable examples of naturally occurring particulate materials for use as proppants include: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc. including such woods that have been processed by grinding, chipping, or other form of particulation, processing, etc. Further information on nuts and composition thereof may be found in ENCYCLOPEDIA OF CHEMICAL TECHNOLOGY, Edited by Raymond E. Kirk and Donald F. Othmer, Third Edition, John Wiley & Sons, vol. 16, pp. 248-273, (1981).

The concentration of proppant in the unviscosified and/or viscosified can be any concentration known in the art. For example, the concentration of proppant in the fluid may be in the range of from about 0.03 to about 3 kilograms of proppant added per liter of liquid phase. Also, any of the proppant particles can further be coated with a resin to potentially improve the strength, clustering ability, and flow back properties of the proppant.

A particulate material may be included in in the unviscosified and/or viscosified to achieve a variety of properties including improving diversion, reducing fluid loss, enhancing solubility, providing delayed neutralization, providing delayed acid release, and the like. Solids used may be hydrophilic or hydrophobic in nature. Solids may be naphthalene balls, benzoic acid salts, rock salt crystals, degradable polymer based particles such as polylactic acid particles, polygylcolic acid particles, lactide particles, polylactide particles, and the like.

A fiber component may be included in the unviscosified and/or viscosified to achieve a variety of properties including improving particle suspension, and particle transport capabilities, and gas phase stability. Fibers used may be hydrophilic or hydrophobic in nature. Fibers can be any fibrous material, such as natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. Suitable fibers may include polyester fibers coated to be highly hydrophilic, such as, but not limited to, polyethylene terephthalate (PET) fibers available from Invista Corp. Wichita, Kans., USA, 67220. Other examples of useful fibers include, but are not limited to, polylactic acid polyester fibers, polyglycolic acid polyester fibers, polyvinyl alcohol fibers, and the like. When used in the unviscosified and/or viscosified fluids, the fiber component may be included at concentrations from about 1 to about 15 grams per liter of the liquid phase of the fluid, such as a concentration of fibers from about 2 to about 12 grams per liter of liquid, or from about 2 to about 10 grams per liter of liquid.

Embodiments may further use unviscosified and/or viscosified fluids containing other additives and chemicals that are known to be commonly used in oilfield applications by those skilled in the art. These include materials such as surfactants in addition to those mentioned hereinabove, breaker activators (breaker aids) in addition to those mentioned hereinabove, oxygen scavengers, alcohol stabilizers, scale inhibitors, corrosion inhibitors, fluid-loss additives, bactericides or biocides such as (ethylenedioxy)dimethanol, or glutaraldehyde, or 2,2-dibromo-3-nitrilopropionamine, and the like. Also, they may include a co-surfactant to optimize viscosity or to minimize the formation of stable emulsions that contain components of crude oil.

### EXAMPLES

The foregoing may be better understood by reference to the following examples, which are presented for purposes of illustration and are not intended to limit the scope of the present disclosure.

### Example 1: Surface Tension Values Study

In order to measure the surface tension of the fluids the du Nouy ring method was used. This involved slowly lifting a platinum ring from the surface of the liquid and measuring the force required to raise the ring from the liquid's surface. This force is related to the surface tension given by the equation: Force=2π×(inner radius+outer radius)×surface tension.

The surface tension of the aqueous fluids being tested should decrease upon addition of a surfactant until a point known as the “critical micelle concentration” (CMC). This is the concentration that micelles form and that any additional surfactant does not further molecularly dissolve, and has effectively coated all surfaces but instead forms micelles.

The following surfactants with improved environmental profile were tested: (1) ARMOCLEAN 4350, a Guerbet C10 alcohol based branched nonionic surfactant based on ethoxylated branched 2-propylheptanol and manufactured by AkzoNobel Surface Chemistry AB, (2) ARMOCLEAN 4250, a Guerbet C10 alcohol based branched nonionic surfactant based on ethoxylated branched 2-propylheptanol and manufactured by AkzoNobel Surface Chemistry AB and (3) NATRASENSE AG810-50, a non-ionic surfactant based on alkyl polyglucoside chemistry and manufactured by Croda Europe Ltd. The concentrations of these surfactants were tested up to 2.3 gpt (gallonUS/1000 gallonUS), with the critical micelle concentration (CMC) often below this concentration. Table 3 below shows the CMC and the lowest surface tension achieved for each surfactant and for each liquid tested these were, tap water (Examples 1.1; 1.7; 1.13), distilled water (Examples 1.2; 1.8; 1.14), synthetic North Sea water (Examples 1.3; 1.9; 1.15), distilled water with 2 gpt organic clay stabilizer (examples 1.4; 1.10; 1.16), 2% KCl in tap water (Examples 1.5; 1.11; 1.17) and 5% HCl (Examples 1.6; 1.12; 1.18). The results in different aqueous-base fluids are shown below in

TABLE 2
Surface Tension and CMC values in various base fluids environmentally friendly surfactants.
ARMOCLEAN 4350

| | | | | Distilled water | | |
|---|---|---|---|---|---|---|
| | | | | with 2 gpt | | |
| | | | | (organic clay | 2% KCl | |
| | Tap water | Distilled water | North Sea water | stabilizer) | In tap water | 5% HCl |
| | (Example 1.1) | (Example 1.2) | (Example 1.3) | (Example 1.4) | (Example 1.5) | (Example 1.6) |
| CMC (gpt) | 0.04 | 0.04 | 0.04 | 0.04 | 0.04 | 0.04 |
| Surface tension | 28.6 | 29.5 | 27.8 | 29.1 | 29.2 | 29.8 |
| (mN/m) | | | | | | |
| (Lowest value) | | | | | | |
| CMC (%) | 0.004 | 0.004 | 0.004 | 0.004 | 0.004 | 0.004 |

NATRASENSE AG810-50

| | | | | Distilled water | | |
|---|---|---|---|---|---|---|
| | | | | with 2 gpt (clay | 2% KCl | |
| | Tap water | Distilled water | North Sea water | stabilizer) | In tap water | 5% HCl |
| | (Example 1.7) | (Example 1.8) | (Example 1.9) | (Example 1.10) | (Example 1.11) | (Example 1.12) |
| CMC (gpt) | 0.2 | 0.16 | 0.08 | 0.16 | 0.12 | 0.12 |
| Surface tension | 27.0 | 27.3 | 27.2 | 27.0 | 27.2 | 27.1 |
| (mN/m) | | | | | | |
| (Lowest value) | | | | | | |
| CMC (%) | 0.02 | 0.016 | 0.008 | 0.016 | 0.012 | 0.012 |

ARMOCLEAN 4250

| | | | | Distilled water | | |
|---|---|---|---|---|---|---|
| | | | | with 2 gpt (clay | 2% KCl | |
| | Tap water | Distilled water | North Sea water | stabilizer) | In tap water | 5% HCl |
| | (Example 1.13) | (Example 1.14) | (Example 1.15) | (Example 1.16) | (Example 1.17) | (Example 1.18) |
| CMC (gpt) | 0.04 | 0.04 | 0.04 | 0.04 | 0.04 | 0.04 |
| Surface tension | 34.5 | 35.2 | 33.6 | 35.2 | 35.3 | 36.1 |
| (mN/m) | | | | | | |
| (Lowest value) | | | | | | |
| CMC (%) | 0.004 | 0.004 | 0.004 | 0.004 | 0.004 | 0.004 |

The following commercially used stimulation surfactants with less acceptable environmental profile were tested: (1) Commercial Stimulation Nonionic surfactant Benchmark 1, a mixture of linear and branched oxo alcohol ethoxylated surfactants, (2) Commercial Stimulation Nonionic surfactant Benchmark 2, a mixture of linear and branched oxo alcohols and linear and branched oxo alcohol ethoxylated surfactants, and (3) Commercial Stimulation Nonionic surfactant Benchmark 3, a proprietary mixture of oxo alcohol ethoxylated surfactants. The concentrations of these surfactants were tested up to 2.3 USgal/1000 USgal (“gpt”), with the critical micelle concentration (CMC) often below this concentration. Table 3 below shows the CMC and the lowest surface tension achieved for each surfactant and for each liquid tested these were, tap water (Examples 1.19; 1.25; 1.31), distilled water (Examples 1.20; 1.26; 1.32), synthetic North Sea water (examples 1.21; 1.27; 1.33), distilled water with 2 gpt organic clay stabilizer (Examples 1.22; 1.28; 1.34), 2% KCl in tap water (Examples 1.23; 1.29; 1.35) and 5% HCl (Examples 1.24; 1.30; 1.36). The results in different aqueous-base fluids are shown in Table 3.

TABLE 3
Surface Tension and CMC values in various base fluids for less
environmentally acceptable commercial stimulation surfactants used as performance benchmarks.
Commercial Stimulation Nonionic surfactant Benchmark 1

| | | | | Distilled water | | |
|---|---|---|---|---|---|---|
| | | | | with 2 gpt (clay | 2% KCl | |
| | Tap water | Distilled water | North Sea water | stabilizer) | In tap water | 5% HCl |
| | (Example 1.19) | (Example 1.20) | (Example 1.21) | (Example 1.22) | (Example 1.23) | (Example 1.24) |
| CMC (gpt) | 0.04 | 0.04 | 0.08 | 0.08 | 0.04 | 0.08 |
| Surface tension | 28.6 | 29.5 | 30.9 | 30.6 | 30.1 | 31.3 |
| (mN/m) | | | | | | |
| (Lowest value) | | | | | | |
| CMC (%) | 0.004 | 0.004 | 0.008 | 0.008 | 0.004 | 0.008 |

Commercial Stimulation Nonionic surfactant Benchmark 2

| | | | | Distilled water | | |
|---|---|---|---|---|---|---|
| | | | | with 2 gpt (clay | 2% KCl | |
| | Tap water | Distilled water | North Sea water | stabilizer) | In tap water | 5% HCl |
| | (Example 1.25) | (Example 1.26) | (Example 1.27) | (Example 1.28) | (Example 1.29) | (Example 1.30) |
| CMC (gpt) | 0.08 | 0.08 | 0.08 | 0.08 | 0.04 | 0.08 |
| Surface tension | 28.2 | 28.5 | 28.7 | 28.5 | 28.9 | 29.0 |
| (mN/m) | | | | | | |
| (Lowest value) | | | | | | |
| CMC (%) | 0.008 | 0.008 | 0.008 | 0.008 | 0.004 | 0.008 |

Commercial Stimulation Nonionic surfactant Benchmark 3

| | | | | Distilled water | | |
|---|---|---|---|---|---|---|
| | | | | with 2 gpt (clay | 2% KCl | |
| | Tap water | Distilled water | North Sea water | stabilizer) | In tap water | 5% HCl |
| | (Example 1.31) | (Example 1.32) | (Example 1.33) | (Example 1.34) | (Example 1.35) | (Example 1.36) |
| CMC (gpt) | 0.08 | 0.08 | 0.04 | 0.08 | 0.04 | 0.08 |
| Surface tension | 28.3 | 28.4 | 28.8 | 28.5 | 28.8 | 28.8 |
| (mN/m) | | | | | | |
| (Lowest value) | | | | | | |
| CMC (%) | 0.008 | 0.008 | 0.004 | 0.008 | 0.004 | 0.008 |

As shown above in Table 3, ARMOCLEAN 4250 showed a high surface tension compared with ARMOCLEAN 4350 and NATRASENSE AG810-50. However, a higher concentration of NATRASENE AG810-50 is required to reach its CMC compared to ARMOCLEAN 4350. These results for the environmentally improved ARMOCLEAN 4350 compared favorably with the values obtained for the less environmentally friendly surfactants shown in Table 3. Both ARMOCLEAN 4350 and ARMOCLEAN 4250 showed low surface tension, below 30 dyne/cm as lowest value, and their respective CMC was low (about 0.04 gpt,) which were as low as, or lower than currently used commercially available stimulation surfactants with a less desirable environmental profile.

### Example 2: Rheology Performance of Fracturing Fluid “A”

In order to check compatibility of ARMOCLEAN 4350 and NATRASENSE AG810-50 in different fracturing fluids, we measured viscosity of various tests and compare results with the commercial stimulation nonionic surfactant Benchmark 1.

A very high pH Fluid “A” was prepared (at pH about 12.5), the components of which are described below in Table 4. To this fluid, ARMOCLEAN 4350, NATRASENSE AG810-50 and commercial stimulation nonionic surfactant Benchmark 1 were added in the amounts shown below in Table 4. The concentration of ARMOCLEAN 4350 and NATRASENSE AG810-50 was 2 gpt, which is the same concentration that was used in the commercial stimulation nonionic surfactant Benchmark 1. Furthermore, in each of the below fluids, sodium gluconate is the delay agent, nitrilotriethanol is the iron stabilizer, alkyl hydroxyethylbenzyl ammonium chloride is the non-emulsifying agent, boric acid is the crosslinker, (ethylenedioxy)dimethanol is the biocide and sodium hydroxide is the activator.

TABLE 4
Fluid “A” formulation:

| Additive | Example 2.1 | Example 2.2 | Example 2.3 |
|---|---|---|---|
| Fresh water | Fresh water 1000 gpt | Fresh water 1000 gpt | Fresh water 1000 gpt |
| 2% Potassium Chloride | 167 ppt | 167 ppt | 167 ppt |
| ARMOCLEAN 4350 Surfactant | 2 gpt | — | — |
| Green Guar Slurry Gel | 12.2 gpt | 12.2 gpt | 12.2 gpt |
| commercial stimulation | — | 2 gpt | — |
| nonionic surfactant | | | |
| Benchmark 1 | | | |
| NATRASENSE AG810-50 | — | — | 2 gpt |
| Non-emulsifying Agent | 2 gpt | 2 gpt | 2 gpt |
| Biocide 1 | 0.25 gpt | 0.25 gpt | 0.25 gpt |
| Activator | 20 gpt | 20 gpt | 20 gpt |
| Crosslinker | 5 ppt | 5 ppt | 5 ppt |
| Delay Agent | 15 ppt | 15 ppt | 15 ppt |
| Iron Stabilizer | 1 gpt | 1 gpt | 1 gpt |
| pH | 12.54 | 12.35 | 12.35 |

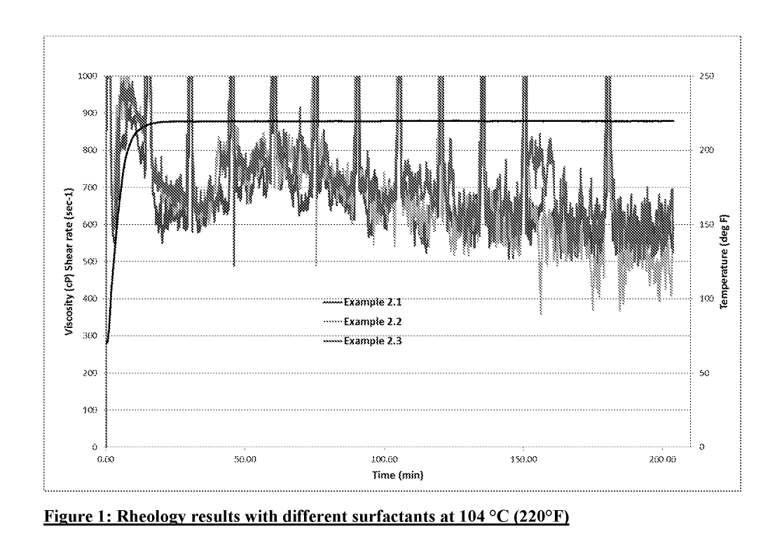

The viscosity of Examples 2.1-2.3 was determined using a Chandler 5550HPHT Viscometer and measured at a shear of 100 sec⁻¹ and a temperature of 104° C. (220° F.). The viscosity results are shown in FIG. 1 demonstrating that the fluid rheology is not affected by the use of the environmentally improved surfactants (Examples 2.1, and 2.3) compared to the commercial stimulation nonionic surfactant Benchmark 1.

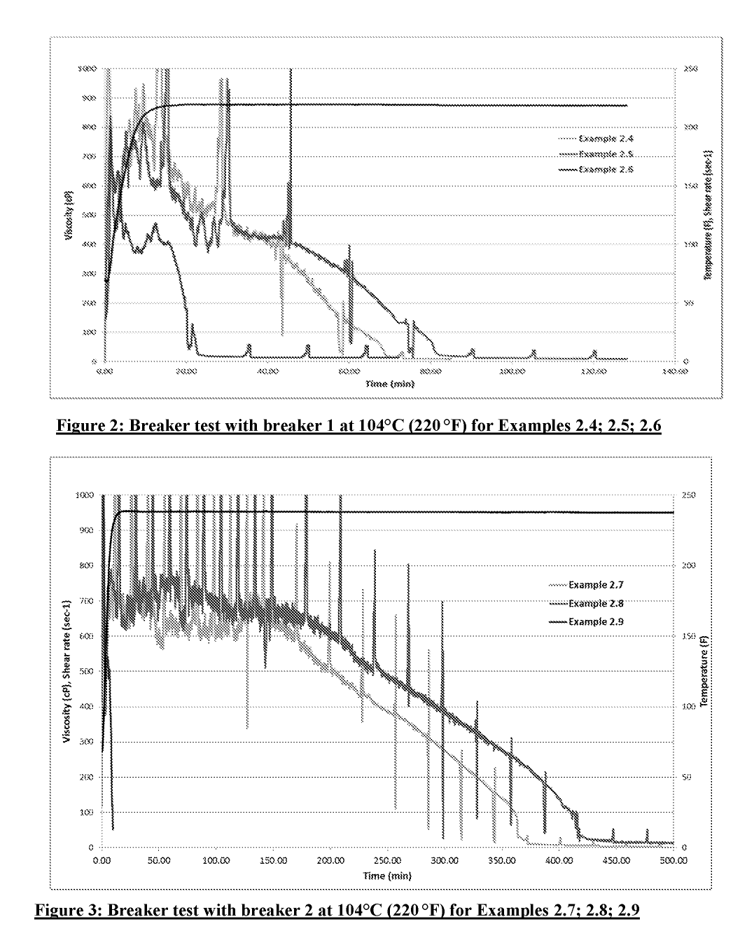

Examples 2.4-2.9 were similar to Examples 2.1-2.3, except these fluids contained a breaker to determine the sensitivity of the break profile to the new environmentally friendly surfactant. “Breaker 1” was sodium chlorite, “Breaker 2” was sodium bromate. The details for Examples 2.4 and 2.9 are shown below in Table 6, and the rheology curves (determined in the same manner as described above) are shown in FIG. 2 (Examples 2.4-2.6) and FIG. 3 (Examples 2.7-2.9).

TABLE 5
Fluid “A” formulation with breaker

| Additive | Example 2.4 | | Example 2.5 | | Example 2.6 | | Example 2.7 | | Example 2.8 | | Example 2.9 | |
|---|---|---|---|---|---|---|---|---|---|---|---|---|
| Fresh water | 1000 | gpt | 1000 | gpt | 1000 | gpt | 1000 | gpt | 1000 | gpt | 1000 | gpt |
| 2% Potassium Chloride | 167 | ppt | 167 | ppt | 167 | ppt | 167 | ppt | 167 | ppt | 167 | ppt |
| ARMOCLEAN 4350 | 2 | | — | | — | | 2 | | — | | — | |
| Surfactant | | | | | | | | | | | | |
| Green Guar Slurry Gel | 12.2 | gpt | 12.2 | gpt | 12.2 | gpt | 12.2 | gpt | 12.2 | gpt | 12.2 | gpt |
| commercial stimulation | — | | 2 | gpt | — | | — | | 2 | gpt | — | |
| nonionic surfactant | | | | | | | | | | | | |
| Benchmark 1 | | | | | | | | | | | | |
| NATRASENSE AG810- | — | | — | | 2 | gpt | — | | — | | 2 | gpt |
| 50 Surfactant | | | | | | | | | | | | |
| Non-emulsifying Agent | 2 | gpt | 2 | gpt | 2 | gpt | 2 | gpt | 2 | gpt | 2 | gpt |
| Biocide 1 | 0.25 | gpt | 0.25 | gpt | 0.25 | gpt | 0.25 | gpt | 0.25 | gpt | 0.25 | gpt |
| Activator | 20 | gpt | 20 | gpt | 20 | gpt | 20 | gpt | 20 | gpt | 20 | gpt |
| Crosslinker 3 | 5 | ppt | 5 | ppt | 5 | ppt | 5 | ppt | 5 | ppt | 5 | ppt |
| Delay Agent | 15 | ppt | 15 | ppt | 15 | ppt | 15 | ppt | 15 | ppt | 15 | ppt |
| Iron Stabilizer | 1 | gpt | 1 | gpt | 1 | gpt | 1 | gpt | 1 | gpt | 1 | gpt |

| | | | | | | | | | |
|---|---|---|---|---|---|---|---|---|---|
| Breaker 1 | 1 | ppt | 1 | gpt | 1 | ppt | — | — | — |

| | | | | | | | | | |
|---|---|---|---|---|---|---|---|---|---|
| Breaker 2 | — | — | — | 5 | ppt | 5 | ppt | 5 | ppt |

| | | | | | | |
|---|---|---|---|---|---|---|
| pH | 12.35 | 12.35 | 12.35 | 12.35 | 12.35 | 12.35 |

As shown in FIGS. 2 and 3, the rheology performance of fluids formulated with ARMOCLEAN 4350 (Example 2.1) and NATRASENSE AG810-50 (Example 2.3) are similar to those formulated with commercial stimulation nonionic surfactant Benchmark 1 (example 2.2). Error! Reference source not found. and Error! Reference source not found. also showed compatibility of ARMOCLEAN 4350 (Example 2.4 and 2.7) and NATRASENSE AG810-50 (Example 2.6 and 2.9) with the system with two different breakers. The ARMOCLEAN 4350 provided a similar break profile to that of commercial stimulation nonionic surfactant Benchmark 1 (Example 2.5 and 2.8), while the NATRASENSE AG810-50 had a markedly different profile resulting in the fluids breaking quicker, which was unexpected and in which under certain conditions can be commercially used to accelerate fluid break using this surfactant as a dual purpose additive (surface active and breaker activator).

### Example 3: Rheology Performance of Fracturing Fluid “B”

A moderately high pH Fluid “B” was prepared (pH about 11.5), the components of which are described below in Table 6. To this fluid, ARMOCLEAN 4350, NATRASENSE AG810-50, commercial stimulation nonionic surfactant Benchmark 1 and commercial stimulation nonionic surfactant Benchmark 2 were added in the amounts shown below in Table 6. The concentration of ARMOCLEAN 4350 and NATRASENSE AG810-50 was 1 gpt, which is the same concentration that was used in the commercial stimulation nonionic surfactant Benchmark 1 and commercial stimulation nonionic surfactant Benchmark 2. Furthermore, in each of the below fluids, sodium gluconate was the delay agent, an organic salt aqueous solution was the clay control agent, potassium borate was the crosslinker 1, and isothiazoline was the biocide 2.

TABLE 6
Fluid “B” formulation

| Additive | Example 3.1 | Example 3.2 | Example 3.3 | Example 3.4 |
|---|---|---|---|---|
| Fresh Water | 1000 gpt | 1000 gpt | 1000 gpt | 1000 gpt |
| Surfactant ARMOCELAN 4350 | 1 gpt | — | — | — |
| commercial stimulation | — | 1 gpt | — | — |
| nonionic surfactant Benchmark 1 | | | | |
| Surfactant NATRASENSE | — | — | 1 gpt | — |
| AG810-50 | | | | |
| commercial stimulation | — | — | — | 1 gpt |
| nonionic surfactant Benchmark 2 | | | | |
| Biocide 2 | 0.3 gpt | 0.3 gpt | 0.3 gpt | 0.3 gpt |
| Green Guar Slurry Gel | 9 gpt | 12.2 gpt | 12.2 gpt | 12.2 gpt |
| Clay Control Additive | 2 gpt | 2 gpt | 2 gpt | 2 gpt |
| Crosslinker 1 | 1.75 gpt | 1.75 ppt | 1.75 ppt | 1.75 ppt |
| Delay Agent | 6 ppt | 6 ppt | 6 ppt | 6 ppt |
| pH | 11.5 | 11.5 | 11.5 | 11.5 |

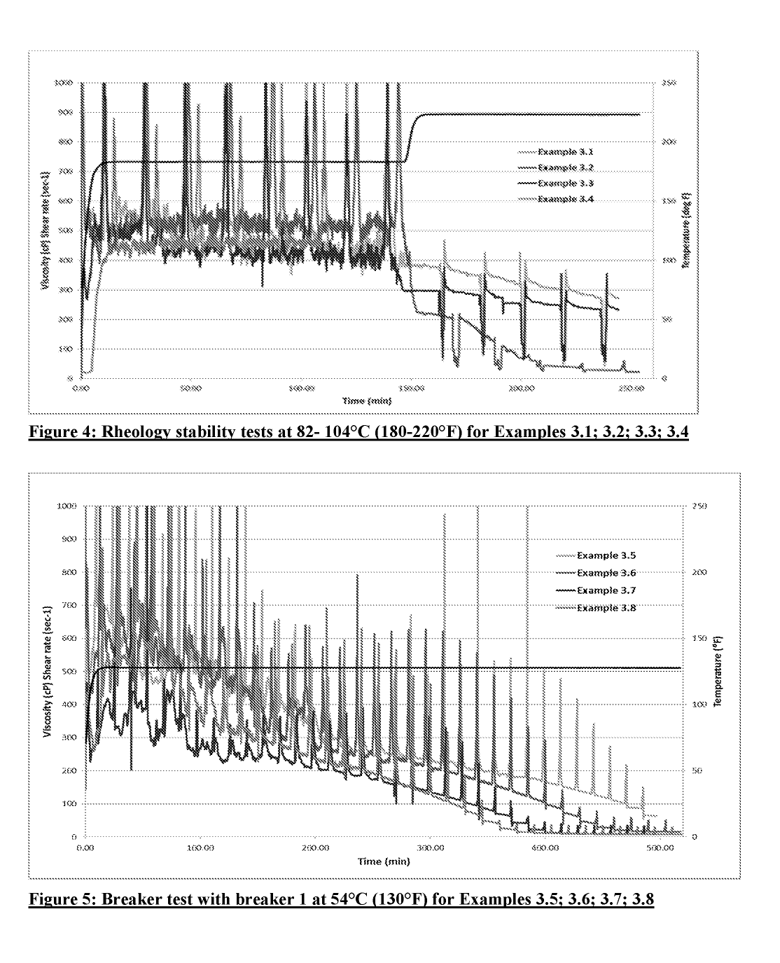

The viscosity of Examples 3.1-3.4 was determined using a CHANDLER 5550HPHT VISCOMETER and measured at a shear of 100 sec-1 and at the following temperature profiles: 82-104° C. (180-220° F.) and 54° C. (130° F.). The viscosity results are shown in FIG. 4.

A moderately high pH Fluid “B” was prepared (pH about 11.5), the components of which are described below in Table 7. To this fluid, ARMOCLEAN 4350, NATRASENSE AG810-50, commercial stimulation nonionic surfactant were added.

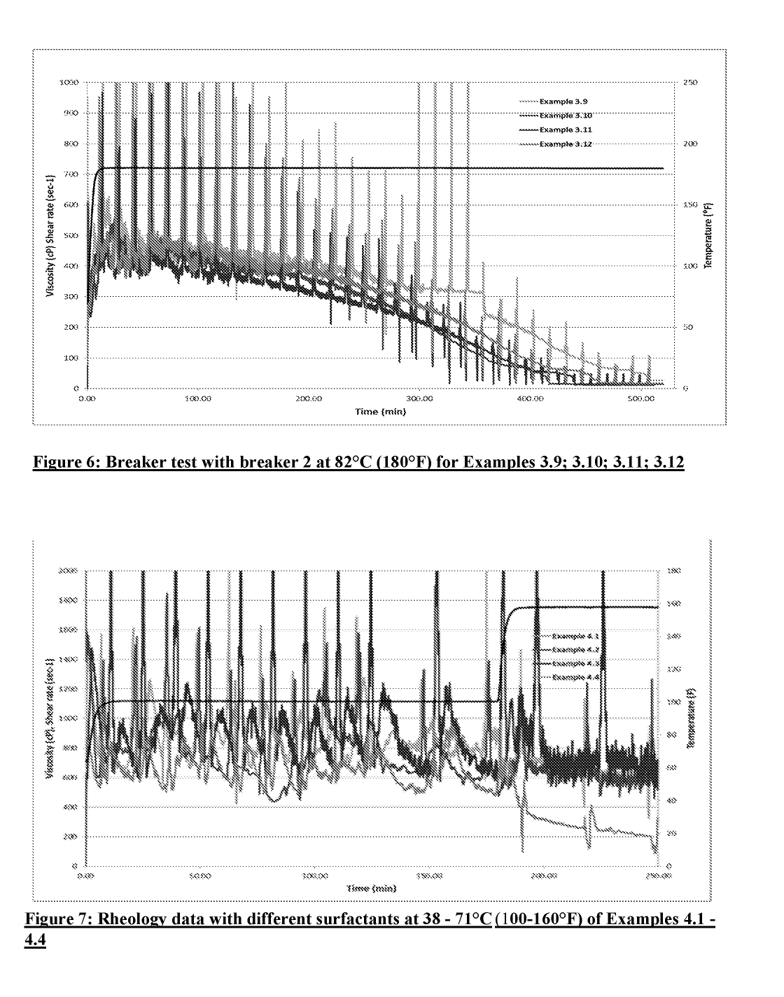

Examples 3.5-3.12 were prepared with similar formulations to those used in Examples 3.1-3.4, except these fluids contained a breaker to determine the sensitivity of the break profile to the new environmentally friendly surfactant. “Breaker 1” was sodium chlorite and “Breaker 3” was diammonium peroxidisulphate. The details for Examples 3.5-3.12 are shown below in Table 7, and the rheology curves (determined in the same manner as described above) are shown in FIG. 5 (Examples 3.5-3.8) and FIG. 6 (Examples 3.9-3.12).

TABLE 7
Fluid “B” formulation with breakers

| | Example | | Example | | Example | | Example | | Example | | Example | | Example | | Example | |
|---|---|---|---|---|---|---|---|---|---|---|---|---|---|---|---|---|
| Additive | 3.5 | | 3.6 | | 3.7 | | 3.8 | | 3.9 | | 3.10 | | 3.11 | | 3.12 | |
| Fresh Water | 1000 | gpt | 1000 | gpt | 1000 | gpt | 1000 | gpt | 1000 | gpt | 1000 | gpt | 1000 | gpt | 1000 | gpt |
| Surfactant ARMOCLEAN | 1 | gpt | — | | — | | — | | 1 | gpt | — | | — | | — | |
| 4350 | | | | | | | | | | | | | | | | |
| commercial stimulation | — | | 1 | gpt | — | | — | | — | | 1 | gpt | — | | — | |
| nonionic surfactant | | | | | | | | | | | | | | | | |
| Benchmark 1 | | | | | | | | | | | | | | | | |
| Surfactant_ | — | | — | | 1 | gpt | — | | — | | — | | 1 | gpt | — | |
| NATRASENSE AG810-50 | | | | | | | | | | | | | | | | |
| commercial stimulation | — | | — | | — | | 1 | gpt | — | | — | | — | | 1 | gpt |
| nonionic surfactant | | | | | | | | | | | | | | | | |
| Benchmark 2 | | | | | | | | | | | | | | | | |
| Biocide 2 | 0.3 | gpt | 0.3 | gpt | 0.3 | gpt | 0.3 | gpt | 0.3 | gpt | 0.3 | gpt | 0.3 | gpt | 0.3 | gpt |
| Green Guar | 9 | gpt | 12.2 | gpt | 12.2 | gpt | 12.2 | gpt | 12.2 | gpt | 12.2 | gpt | 12.2 | gpt | 12.2 | gpt |
| Slurry Gel | | | | | | | | | | | | | | | | |
| Clay Control Additive | 2 | gpt | 2 | gpt | 2 | gpt | 2 | gpt | 2 | gpt | 2 | gpt | 2 | gpt | 2 | gpt |
| Crosslinker 1 | 1.75 | gpt | 1.75 | ppt | 1.75 | ppt | 1.75 | ppt | 1.75 | ppt | 1.75 | ppt | 1.75 | ppt | 1.75 | ppt |
| Delay Agent | 6 | ppt | 6 | ppt | 6 | ppt | 6 | ppt | 6 | ppt | 6 | ppt | 6 | ppt | 6 | ppt |
| Breaker 3 at 54° C. | 1 | | 1 | | 1 | | 1 | | — | | — | | — | | — | |
| Breaker 1 | — | | — | | — | | — | | 10 | | 10 | | 10 | | 10 | |
| at 82° C. | | | | | | | | | | | | | | | | |

As can be seen in FIG. 4, the rheology performance of the fluids formulated with ARMOCLEAN 4350 surfactant (Example 3.1) and NATRASENSE AG810-50 (Example 3.3) is similar to that of the fluids formulated commercial stimulation nonionic surfactant Benchmark 1 (Example 3.2), and commercial stimulation nonionic surfactant Benchmark 2 (Example 3.4) at 180° F., with all fluids effectively reducing their viscosity as required at 220° F. Error! Reference source not found. and Error! Reference source not found. also showed compatibility of ARMOCLEAN 4350 (Example 3.4 and 3.7) and NATRASENSE AG810-50 (Example 3.6 and 3.9) with the system with two different breakers at 130° F. The ARMOCLEAN 4350 surfactant provided a similar break profile to that of the fluids containing the commercial stimulation nonionic surfactant Benchmark 1 and commercial stimulation nonionic surfactant Benchmark 2 (comparing examples 3.5, 3.6 and 3.8 respectively at 130° F., and comparing Examples 3.9, 3.10 and 3.12 respectively at 180° F.) whilst the fluids containing NATRASENSE AG810-50 had a markedly different profile resulting in the fluids achieving a lower viscosity, and ultimately breaking faster. Comparing the results obtained for ARMOCLEAN 4350 to all others it can be observed that those fluid formulated with this environmentally acceptable surfactant exhibited a substantially enhanced stability both in the presence and the absence of commonly used surfactants, which is an unexpected result and indicates that this class of environmentally acceptable surfactants can be used as a multifunctional additive, that in addition to providing reduction of the surface tension of the fluid, can also stabilize the fracturing fluid during the pumping stage, without a negative impact on the breaking profile.

Furthermore, as can be seen in Error! Reference source not found., ARMOCLEAN 4350 (Example 3.1) and NATRASENSE AG810-50 (Example 3.3) are similar to commercial stimulation nonionic surfactant Benchmark 1 (Example 3.2) and commercial stimulation nonionic surfactant Benchmark 2 (Example 3.4). The rheology performance of the fluid containing the new environmentally improved surfactants (Example 3.1 and 3.3) shows they are compatible with this design and showed a substantially similar performance indicating they can be used in fracturing fluids similarly to commercial stimulation nonionic surfactant Benchmark 1 (Example 3.2) and commercial stimulation nonionic surfactant Benchmark 2 (Example 3.4). The same fluid “B” as shown in Table 7 was tested with two different breakers. As shown in FIGS. 5 and 6, both breakers are compatible with new environmental friendly surfactants ARMOCLEAN 4350 and NATRASENSE AG810-50.

### Example 4: Rheology Performance of Fracturing Fluid “C”

A fracturing fluid Fluid “C” (pH of about 10) was prepared in sea water, the components of which are described below in Table 8. Ensuring compatibility with sea water formulated fracturing fluids is a key performance for the use of the environmentally acceptable surfactants disclosed herein as the use of sea water as a make-up brine for the fluid provides substantial economic benefits to off-shore operations minimizing the need to perform long trips to port to re-stock fresh water. To this fluid, the environmentally improved surfactants ARMOCLEAN 4350, NATRASENSE AG810-50, and the commercial stimulation nonionic surfactant Benchmark 1 and commercial stimulation nonionic surfactant Benchmark 2 were included in the formulation in the amounts shown below in Table 8. The concentration of ARMOCLEAN 4350 and NATRASENSE AG810-50 was 1 gpt, which is the same concentration that was used in the commercial stimulation nonionic surfactant Benchmark 1 and commercial stimulation nonionic surfactant Benchmark 2. Furthermore, in each of the below fluids, guar is the gelling agent, sodium gluconate is the delay agent, an organic salt aqueous solution is the clay control additive, potassium borate is the crosslinker and (ethylenedioxy)dimethanol is the biocide.

TABLE 8
Formulation of fluid “C”

| Additive | Example 4.1 | | Example 4.2 | | Example 4.3 | | Example 4.4 | | Example 4.5 | | Example 4.6 | | Example 4.7 | | Example 4.8 | |
|---|---|---|---|---|---|---|---|---|---|---|---|---|---|---|---|---|
| Sea Water | 1000 | gpt | 1000 | gpt | 1000 | gpt | 1000 | gpt | 1000 | gpt | 1000 | gpt | 1000 | gpt | 1000 | gpt |
| Surfactant | 1 | gpt | — | | — | | — | | 1 | gpt | — | | — | | — | |
| ARMOCELAN | | | | | | | | | | | | | | | | |
| 4350 | | | | | | | | | | | | | | | | |
| commercial | — | | 1 | gpt | — | | — | | — | | 1 | gpt | — | | — | |
| stimulation | | | | | | | | | | | | | | | | |
| nonionic | | | | | | | | | | | | | | | | |
| surfactant | | | | | | | | | | | | | | | | |
| Benchmark 1 | | | | | | | | | | | | | | | | |
| Surfactant | — | | — | | 1 | gpt | — | | — | | — | | 1 | gpt | — | |
| NATRASENSE | | | | | | | | | | | | | | | | |
| AG810-50 | | | | | | | | | | | | | | | | |
| commercial | — | | — | | — | | 1 | gpt | — | | — | | — | | 1 | gpt |
| stimulation | | | | | | | | | | | | | | | | |
| nonionic | | | | | | | | | | | | | | | | |
| surfactant | | | | | | | | | | | | | | | | |
| Benchmark 2 | | | | | | | | | | | | | | | | |
| Biocide 1 | 0.2 | gpt | 0.2 | gpt | 0.2 | gpt | 0.2 | gpt | 0.2 | gpt | 0.2 | gpt | 0.2 | gpt | 0.2 | gpt |
| Green Guar | 9.2 | gpt | 9.2 | gpt | 9.2 | gpt | 9.2 | gpt | 9.2 | gpt | 9.2 | gpt | 9.2 | gpt | 9.2 | gpt |
| Slurry Gel | | | | | | | | | | | | | | | | |
| Clay Control | 2 | gpt | 2 | gpt | 2 | gpt | 2 | gpt | 2 | gpt | 2 | gpt | 2 | gpt | 2 | gpt |
| Additive | | | | | | | | | | | | | | | | |
| Crosslinker 1 | 4 | gpt | 4 | ppt | 4 | ppt | 4 | ppt | 4 | gpt | 4 | ppt | 4 | ppt | 4 | ppt |
| Delay Agent | 25 | ppt | 25 | ppt | 25 | ppt | 25 | ppt | 25 | ppt | 25 | ppt | 25 | ppt | 25 | ppt |

| | | | | | | | | |
|---|---|---|---|---|---|---|---|---|
| pH | 10.0 | 10.50 | 10.50 | 10.50 | 10.50 | 10.50 | 10.50 | 10.50 |

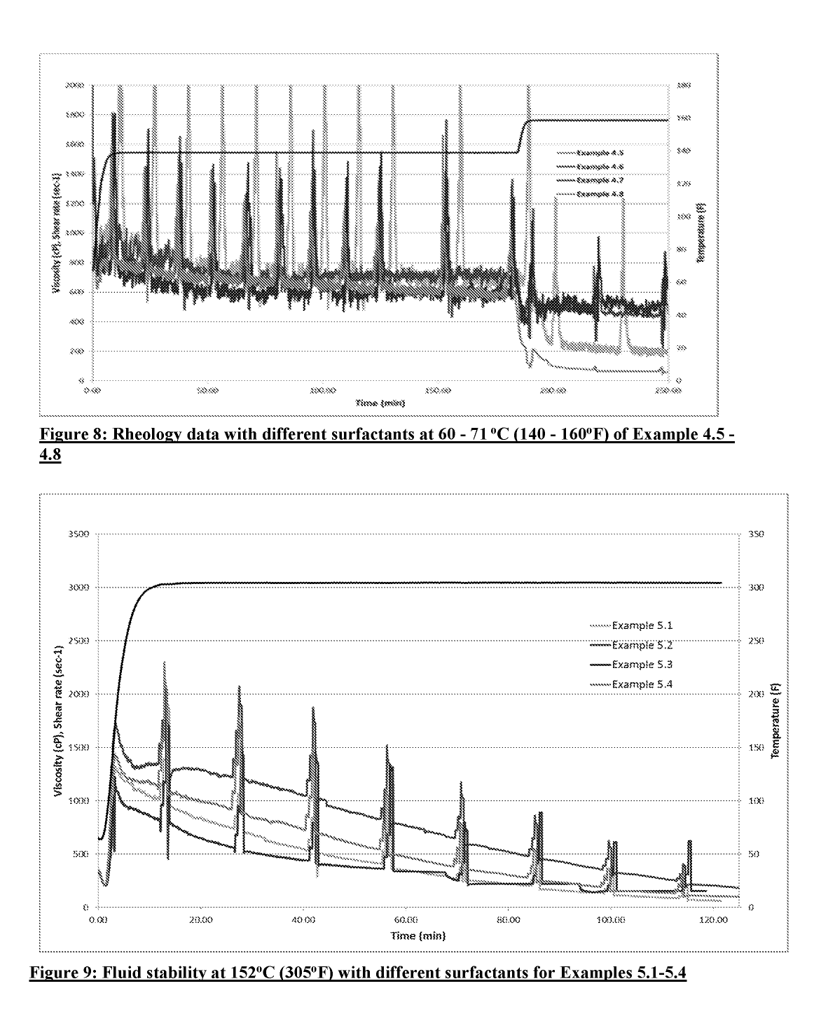

The viscosities of Examples 4.1-4.8 were determined using a CHANDLER 5550 HPHT VISCOMETER and measured at a shear of 100 sec¹ and a temperature of 38-71° C. (100-160° F.) and 60-71° C. (140-160° F.). The viscosity results are shown in FIGS. 7 and 8.

As shown in FIGS. 7 and 8, the fluids containing the environmentally improved surfactant ARMOCLEAN 4350, (Example 4.1), and environmentally improved surfactant ARMOCLEAN 4350, (Example 4.3) performs similarly to the commercial stimulation nonionic surfactant Benchmark 1 (Example 4.2) and commercial stimulation nonionic surfactant Benchmark 2 (Example 4.4) at 38-71° C. (100-160° F.). Also similar performance is observed at 60-71° C. (140-160° F.) (Examples 4.5; 4, 6; 4.7; 4.8) whereby no incompatibility issues are noted for this fluid formulation “C”.

### Example 5: Rheology Performance of Fracturing Fluid “D”

A fracturing fluid Fluid “D” (pH of about 8.2) was prepared and designed to be used at temperatures up to 152° C. (305° F.), the components of which are described below in Table 9. To this fluid, the environmentally improved surfactants ARMOCLEAN 4350, NATRASENSE AG810-50 and commercial stimulation nonionic surfactant Benchmark 2 were added in the amounts shown below in Table 9. The concentration of ARMOCLEAN 4350 and NATRASENSE AG810-50 was 2 gpt, which is the same concentration that was used in the commercial stimulation nonionic surfactant Benchmark 2. Furthermore, in each of the below fluids, sea water, CMHPG (carboxymethylhydroxypropyl guar), an anionic guar derivative used as the gelling agent, an organic salt aqueous solution as the clay control additive, caustic soda as the pH modifier, an aqueous solution of sodium diacetate as the acid buffer, an inorganic salt as the high temperature stabilizer, a boron-zirconate dual metal crosslinker. Fluid stability tests were performed with the different surfactants at 305° F. In addition fluid breaker tests were performed to confirm the compatibility of the new environmentally improved surfactants in fluid “D”.

TABLE 9
Formulation of fluid “D”

| Additive | Example 5.1 | | Example 5.2 | | Example 5.3 | | Example 5.4 | | Example 5.5 | | Example 5.6 | | Example 5.7 | | Example 5.8 | |
|---|---|---|---|---|---|---|---|---|---|---|---|---|---|---|---|---|
| Sea Water | 1000 | gpt | 1000 | gpt | 1000 | gpt | 1000 | gpt | 1000 | gpt | 1000 | gpt | 1000 | gpt | 1000 | gpt |
| Surfactant | 1 | gpt | — | | — | | — | | 1 | gpt | — | | — | | — | |
| ARMOCELAN 4350 | | | | | | | | | | | | | | | | |
| commercial stimulation | — | | 1 | gpt | — | | — | | — | | 1 | gpt | — | | — | |
| nonionic surfactant | | | | | | | | | | | | | | | | |
| Benchmark 1 | | | | | | | | | | | | | | | | |
| Surfactant | — | | — | | 1 | gpt | — | | — | | — | | 1 | gpt | — | |
| NATRASENSE AG810- | | | | | | | | | | | | | | | | |
| 50 | | | | | | | | | | | | | | | | |
| commercial stimulation | — | | — | | — | | 1 | gpt | — | | — | | — | | 1 | gpt |
| nonionic surfactant | | | | | | | | | | | | | | | | |
| Benchmark 2 | | | | | | | | | | | | | | | | |
| CMHPG | 18.2 | gpt | 18.2 | gpt | 18.2 | gpt | 18.2 | gpt | 18.2 | gpt | 18.2 | gpt | 18.2 | gpt | 18.2 | gpt |
| Clay Control Additive | 2 | gpt | 2 | gpt | 2 | gpt | 2 | gpt | 2 | gpt | 2 | gpt | 2 | gpt | 2 | gpt |
| Acid buffer | 1 | gpt | 1 | gpt | 1 | gpt | 1 | gpt | 1 | gpt | 1 | gpt | 1 | gpt | 1 | gpt |
| High Temperature | 20 | ppt | 20 | ppt | 20 | ppt | 20 | ppt | 20 | ppt | 20 | ppt | 20 | ppt | 20 | ppt |
| stabilizer | | | | | | | | | | | | | | | | |
| High Temperature | 1.3 | gpt | 1.3 | ppt | 1.3 | ppt | 1.3 | ppt | 1.3 | ppt | 1.3 | ppt | 1.3 | ppt | 1.3 | ppt |
| Crosslinker | | | | | | | | | | | | | | | | |
| pH modifier | 1.3 | ppt | 1.3 | ppt | 1.3 | ppt | 1.3 | ppt | 1.3 | ppt | 1.3 | ppt | 1.3 | ppt | 1.3 | ppt |

| | | | | | | | | | | | | |
|---|---|---|---|---|---|---|---|---|---|---|---|---|
| Breaker2 | — | — | — | — | 2 | ppt | 2 | ppt | 2 | ppt | 2 | ppt |

| | | | | | | | | |
|---|---|---|---|---|---|---|---|---|
| pH | 8.2 | 8.2 | 8.2 | 8.2 | 8.2 | 8.2 | 8.2 | 8.2 |

The viscosity of Examples 5.1-5.8 was determined using a Chandler 5550 HPHT Viscometer and measured at a shear of 100 sec¹ and a temperature of 152° C. (305° F.). The viscosity results are shown in FIG. 9.

As can be seen in Error! Reference source not found. the sea water based fluids formulated containing the environmentally improved surfactants ARMOCLEAN 4350 (Example 5.1) and NATRASENSE AG810-50 (Example 5.3) showed only slightly reduced viscosity compared to the sea water based fluid with commercial stimulation nonionic surfactant Benchmark 1 (Example 5.2) and commercial stimulation nonionic surfactant Benchmark 2 (Example 5.4) at temperature of 152° C. (305° F.), but yet acceptable for the treatment.

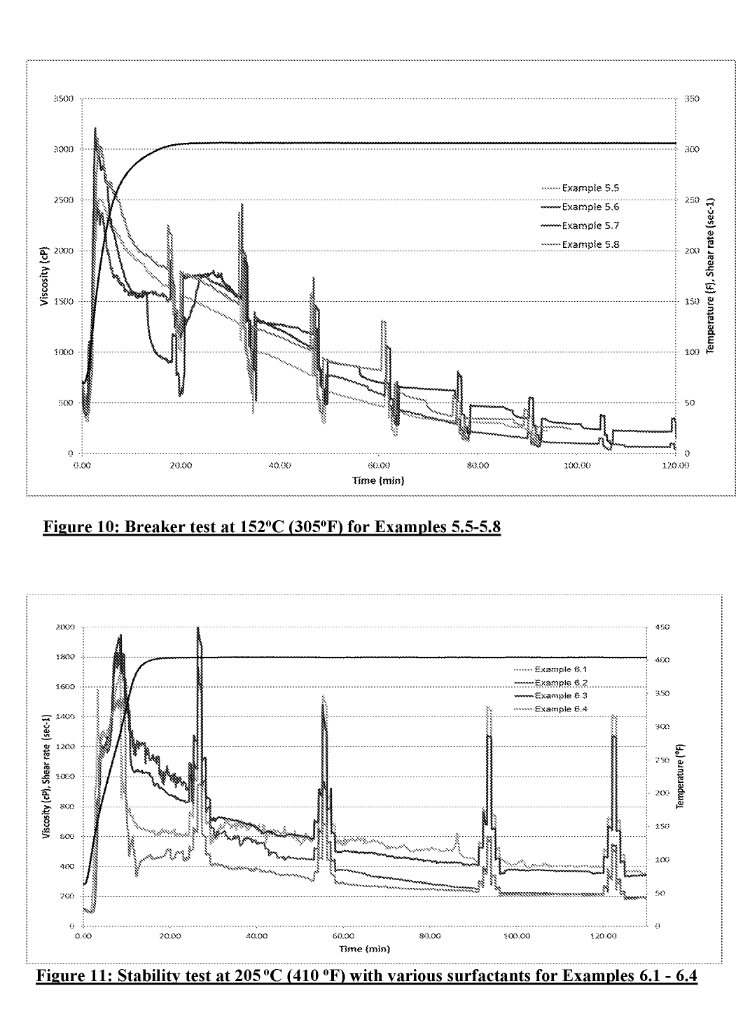

As shown in Table 9 above, Examples 5.5-5.8 were similar to Examples 5.1-5.4, with the exception that these fluids were formulated containing a breaker (“Breaker 2” which was sodium bromate) to determine the sensitivity of the break profile with the new environmentally friendly surfactants. The rheology curves (determined in the same manner as described previously) are shown in FIG. 10.

As can be seen in Error! Reference source not found., ARMOCLEAN 4350 (Example 5.5) and NATRASENSE AG810-50 (Example 5.7) are compatible with breaker 2 at 152° C. (305° F.).

### Example 6: Rheology Performance of Fracturing Fluid “E”

A fracturing fluid “Fluid ‘E” (pH of about 8) was prepared and designed to be used at temperatures up to 232° C. (450° F.), with the components described in Table 10. To this fluid, the environmentally improved surfactants ARMOCLEAN 4350, NATRASENSE AG810-50 (Examples 6.1 and 6.3 respectively) and commercial stimulation nonionic surfactant Benchmark 1 (Example 6.2) and commercial stimulation nonionic surfactant Benchmark 3 (Example 6.2) were added in the amounts shown below in Table 10. The concentration of ARMOCLEAN 4350 and NATRASENSE AG810-50 was 2 gpt, which is the same concentration that was used in the commercial stimulation nonionic surfactants Benchmark 1, and commercial stimulation nonionic surfactants Benchmark 3. Furthermore, in the formulated fluids, a functional synthetic polymer (a copolymer comprising acrylamide) was used as the gelling agent, an organic salt aqueous solution as the clay control additive, a zirconium derivative as the crosslinker, and an inorganic salt as the high temperature stabilizer.

TABLE 10
Formulation of fluid “E”

| | Example | | Example | | Example | | Example | | Example | | Example | | Example | | Example | |
|---|---|---|---|---|---|---|---|---|---|---|---|---|---|---|---|---|
| Additive | 6.1 | | 6.2 | | 6.3 | | 6.4 | | 6.5 | | 6.6 | | 6.7 | | 6.8 | |
| Fresh water | 1000 | gpt | 1000 | gpt | 1000 | gpt | 1000 | gpt | 1000 | gpt | 1000 | gpt | 1000 | gpt | 1000 | gpt |
| Surfactant | 1 | gpt | — | | — | | — | | 1 | gpt | — | | — | | — | |
| ARMOCELAN | | | | | | | | | | | | | | | | |
| 4350 | | | | | | | | | | | | | | | | |
| commercial | — | | 1 | gpt | — | | — | | — | | 1 | gpt | — | | — | |
| stimulation | | | | | | | | | | | | | | | | |
| nonionic surfactant | | | | | | | | | | | | | | | | |
| Benchmark 1 | | | | | | | | | | | | | | | | |
| Surfactant | — | | — | | 1 | gpt | — | | — | | — | | 1 | gpt | — | |
| NATRASENSE | | | | | | | | | | | | | | | | |
| AG810-50 | | | | | | | | | | | | | | | | |
| commercial | — | | — | | — | | 1 | gpt | — | | — | | — | | 1 | gpt |
| stimulation | | | | | | | | | | | | | | | | |
| nonionic surfactant | | | | | | | | | | | | | | | | |
| Benchmark 3 | | | | | | | | | | | | | | | | |
| Gelling agent | 20 | gpt | 20 | gpt | 20 | gpt | 20 | gpt | 20 | gpt | 20 | gpt | 20 | gpt | 20 | gpt |
| Clay Control | 2 | gpt | 2 | gpt | 2 | gpt | 2 | gpt | 2 | gpt | 2 | gpt | 2 | gpt | 2 | gpt |
| Additive | | | | | | | | | | | | | | | | |
| Crosslinker 2 | 4 | gpt | 4 | ppt | 4 | ppt | 4 | ppt | 4 | ppt | 4 | ppt | 4 | ppt | 4 | ppt |
| High temperature | 5 | ppt | 5 | ppt | 5 | ppt | 5 | ppt | 5 | ppt | 5 | ppt | 5 | ppt | 5 | ppt |
| stabilizer | | | | | | | | | | | | | | | | |

| | | | | | | | | | | | | |
|---|---|---|---|---|---|---|---|---|---|---|---|---|
| Breaker 2 | — | — | — | — | 0.2 | ppt | 0.2 | ppt | 0.2 | ppt | 0.2 | ppt |

| | | | | | | | | |
|---|---|---|---|---|---|---|---|---|
| pH | 8.0 | 8.0 | 8.0 | 8.0 | 8.0 | 8.0 | 8.0 | 8.0 |

The viscosity of the fluids prepared in Examples 6.1-6.8 was determined using a Chandler 5550 HPHT Viscometer and measured at a shear of 100 sec⁻¹ at a temperature of 205° C. (410° F.). The viscosity results for the fluids without breaker in Examples 6.1-6.4 are shown in FIG. 11.

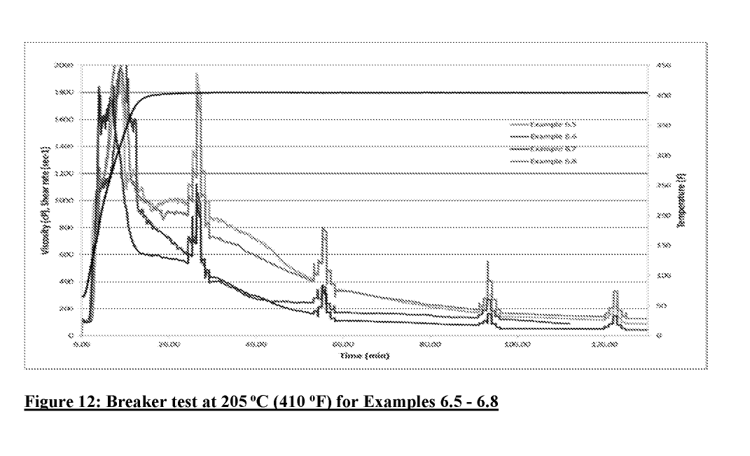

Examples 6.5-6.8 were similar to Examples 6.1-6.4, with the exception that these fluids contained a breaker (“Breaker 2” which was sodium bromate) to determine the sensitivity of the break profile to the use of the new environmentally friendly surfactant. The details for Examples 6.5-6.8 are shown above in Table 10 and the rheology curves (determined in the same manner as described before) are shown in FIG. 12.

The fluid stability and breaker testing was carried out at 205° C. (410° F.). These results are shown in Error! Reference source not found. and FIG. 12. Error! Reference source not found. showed the performance of the environmentally improved new surfactants ARMOCLEAN 4350 (Example 6.1) and NATRASENSE AG810-50 (Example 6.3) have a slightly higher rheology profile compared with the commercial stimulation nonionic surfactant Benchmark 1 (Example 6.2) and commercial stimulation nonionic surfactant Benchmark 3 (Example 6.4) at 205° C. (410° F.)_The compatibility test with breaker 2 is shown in Error! Reference source not found. The environmentally improved surfactants ARMOCLEAN 4350 (Example 6.5) and NATRASENSE AG810-50 (Example 6.7) are compatible with the fluids, and the performance of breaker 2 at 205° C. (410° F.) is not substantially affected, showing a similar breaking time as fluid with commercial stimulation nonionic surfactant Benchmark 1 (Example 6.6) and commercial stimulation nonionic surfactant Benchmark 3 (Example 6.8).

### Example 7: Emulsion Break Test Performance of Matrix Acidizing Fluid “F”

Environmentally acceptable surfactants, such as those described in this disclosure, with low CMC and low surface tension in a variety of aqueous solvents, can be used in a variety of applications, for which their functional properties need to be assessed. Examples includes delivering acceptable performance in fracturing fluid designs in a variety of condition, without major change to the fluid performance as compared to the fluids formulated with less environmentally acceptable surfactants currently in use in the industry (Examples 1.1-1.18, 2.1-2.9, 3.1-3.12, 4.1-4.8, 5.1-5.8 and 6.1-6.8), but also in gravel packing fluids, in well clean-out fluids, mud displacement fluids, in mud clean-out fluids, in water control fluids, or in acid fracturing, and acid treatments fluids, and the like.

In addition to showing compatibility with fracturing fluids, the fluids formulated comprising the environmentally acceptable surfactants of this invention need to be compatible with acid, and downhole oils as currently used in the industry. To ensure that the environmentally improved ARMOCLEAN 4350 did not cause any stable emulsion or created sludge compatibility problems compared to the commercial stimulation nonionic surfactant Benchmark 1, a 28% HCl acid treatment were prepared and emulsion break-out tests were performed at 79° C. (175° F.).

A Fluid “F” was prepared, the components of which are described below in Table 11. To this fluid the environmentally improved surfactant ARMOCLEAN 4350 was used in the formulation as a surfactant (Example 7.2). A commercially nonionic surfactant Benchmark 1 was also used in a comparative fluid. In both fluids, an organic mixture was used as the corrosion inhibitor, formic acid was used as the inhibitor aid, alkyl hydroxyethylbenzyl ammonium chloride was used as the non-emulsifying agent and a synthetic polymer slurry was used as friction reducer.

TABLE 11
Fluid “F” formulation

| | Concentration | Concentration |
|---|---|---|
| Additive | Example 7.1 | Example 7.2 |
| Distilled water | 236.7 gpt | 236.7 gpt |
| 37% HCl | 727.7 gpt | 727.7 gpt |
| Surfactant ARMOCELAN 4350 | 2 gpt | — |
| commercial stimulation nonionic | — | 2 gpt |
| surfactant Benchmark 1 | | |
| Corrosion inhibitor | 6 gpt | 6 gpt |
| Inhibitor aid | 30 gpt | 30 gpt |
| Non-emulsifier | 2 gpt | 2 gpt |
| Friction reducer | 1.15 gpt | 1.15 gpt |

The emulsion test was performed between crude oil and 28% HCl. The appropriate volumes of crude oil and the 28% HCl fluid were combined in selected ratios (25:75, 50:50, 75:25) and mixed at low speed on a Hamilton Beech mixer for 30 seconds. The combined fluid samples were placed in the water bath and their phase behavior monitored periodically for signs of aqueous phase oil phase separation as per Table 12.

TABLE 12
Fluid “F” formulation evaluation

| | Test Number | | | | | | | |
|---|---|---|---|---|---|---|---|---|
| | 1 | 2 | 3 | 4 | 5 | 6 | 7 | 8 |
| Acid/Oil | 25:75 | 50:50 | 50:50 | 50:50 | 75:25 | 25:75 | 50:50 | 75:25 |
| ratio | | | | | | | | |
| Fines added | 2.5 g | 5.0 g | — | — | 7.5 g | — | — | — |
| 3000 ppm | — | — | — | 1.46 g | — | — | — | — |
| Fe(III) | | | | | | | | |
| added | | | | | | | | |
| Acid Live or | Live | Live | Live | Live | Live | Spent | Spent | Spent |
| Spent | | | | | | | | |

Example 7.1

| | | | | | | | | |
|---|---|---|---|---|---|---|---|---|
| 90% | 2 | 1 | 1 | 60 | 1 | 1 | 1 | 2 |
| Breakout | | | | | | | | |
| time (mm) | | | | | | | | |

Example 7.2

| | | | | | | | | |
|---|---|---|---|---|---|---|---|---|
| 90% | 1 | 1 | 1 | 45 | 1 | 2 | 1 | 1 |
| Breakout | | | | | | | | |
| time (mm) | | | | | | | | |

As can be seen from the results the fluids formulated with ARMOCLEAN 4350 and with the commercial stimulation nonionic surfactant Benchmark 1 exhibited similar emulsion breakout times for this particular design “F”.

### Example 8: Emulsion Break Test Performance of Matrix Acidizing Fluid “G”

A 15% HCl and crude oil compatibility and emulsion break-out test was prepared and an emulsion break-out test was performed at 79° C. (175° F.).

Fluid “G” was prepared, with the components described in Table 13. The environmentally improved surfactant ARMOCLEAN 4350 was used as a surfactant (Example 8.1); also a commercial nonionic surfactant Benchmark 1 was also used in a comparative fluid (Example 8.2). In both fluids, an organic mixture was the corrosion inhibitor, formic acid was used as inhibitor aid, alkyl hydroxyethylbenzyl ammonium chloride was used as non-emulsifying agent and a synthetic polymer slurry was used as friction reducer.

TABLE 13
Fluid “G” formulation

| | Concentration | Concentration |
|---|---|---|
| Additive | Example 8.1 | Example 8.2 |
| Distilled water | 619.65 gpt | 619.65 gpt |
| 37% HCl | 367.3 gpt | 367.3 gpt |
| Surfactant ARMOCELAN 4350 | 2 gpt | — |
| Commercial stimulation nonionic | — | 2 gpt |
| smfactant Benchmark 1 | | |
| Corrosion inhibitor | 5 gpt | 5 gpt |
| Inhibitor aid | 10 gpt | 10 gpt |
| Non-emulsifier | 2 gpt | 2 gpt |
| Friction reducer | 1.15 gpt | 1.15 gpt |

The emulsion break-out test was performed between crude oil and 15% HCl. The appropriate volumes of crude oil and the 15% HCl fluid were combined in selected ratios (25:75, 50:50, 75:25) and mixed at low speed on a Hamilton Beech mixer for 30 seconds. The combined fluid samples were placed in the water bath and monitored periodically for signs of aqueous phase-oil phase separation, as per Table 14.

TABLE 14
Fluid “G” formulation evaluation

| | Test Number | | | | | | | |
|---|---|---|---|---|---|---|---|---|
| | 1 | 2 | 3 | 4 | 5 | 6 | 7 | 8 |
| Acid/Oil | 25:75 | 50:50 | 50:50 | 50:50 | 75:25 | 25:75 | 50:50 | 75:25 |
| ratio | | | | | | | | |
| Fines added | 2.5 g | 5.0 g | — | — | 7.5 g | — | — | — |
| 3000 ppm | — | — | — | 1.46 g | — | — | — | — |
| Fe(III) | | | | | | | | |
| added | | | | | | | | |
| Acid Live or | Live | Live | Live | Live | Live | Spent | Spent | Spent |
| Spent | | | | | | | | |

Example 8.1

| | | | | | | | | |
|---|---|---|---|---|---|---|---|---|
| 90% | 2 | 1 | 1 | >120 | 1 | 1 | 1 | 1 |
| Breakout | | | | | | | | |
| time (mm) | | | | | | | | |

Example 8.2

| | | | | | | | | |
|---|---|---|---|---|---|---|---|---|
| 90% | 2 | 1 | 1 | >120 | 2 | 2 | 1 | 1 |
| Breakout | | | | | | | | |
| time (mm) | | | | | | | | |

As can be seen from the results the environmentally improved surfactant ARMOCLEAN 4350 and the commercial stimulation nonionic surfactant Benchmark 1 exhibited similar emulsion breakout times for this particular design “G”.

Although only a few example embodiments have been described in detail herein, those skilled in the art of stimulation fluid formulation will readily appreciate that many modifications are possible in the example embodiments without materially departing from the disclosed ENVIRONMENTALLY ACCEPTABLE SURFACTANT IN AQUEOUS-BASED STIMULATION FLUIDS. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A method of treating a subterranean formation penetrated by a wellbore, the method comprising:
introducing a treatment fluid comprised at least a surfactant comprised of at least a branched ethoxylated surfactant to the subterranean formation.

2. The method of claim 1, wherein the branched ethoxylated surfactant has the structure of Formula 1:
CH₃—[CH₂]ₐ—CH{[CH₂]_{b}—CH₃}—[CH₂]_{c}—[—O—CH₂—CH₂—]ₓ—OH, (1)
wherein a, b, and c are integers that are each greater than or equal to 0, and
wherein a≤y−3, b≤y−3, c≤y−3,
y being an integer greater than or equal to 6 and less than or equal to 36, and is defined as the sum of the integer 3 and a, b and c (y=a+b+c+3) and
wherein x is an integer of from about 1 to about 12.

3. The method of claim 1, wherein the branched ethoxylated surfactant has the structure of Formula 2:
CH₃—[CH₂]_{d}—CH{[CH₂]ₑ—CH₃}—CH₂—[—O—CH₂—CH₂-]ₓ-OH, (2)
wherein d and e are integers that are each greater than or equal to 0,
wherein d≤z−4, e≤z−4,
z being an integer greater than or equal to 6 and less than or equal to 36, and is as the sum of the integer 4 and e, d and c (z=d+e+4) and
wherein x is an integer of from about 1 to about 12.

4. The method of claim 1, wherein the branched ethoxylated surfactant has the structure of Formula 3:
CH₃—[CH₂]_{f}—[CH₂]₂—CH{[CH₂]_{f}—CH₃}—CH₂—[—O—CH₂—CH₂-]ₓ-OH, (3)
wherein f is an integer and is greater than or equal to 1 and
wherein x is an integer of from about 1 to about 12.

5. The method of claim 1, wherein the branched alcohol ethoxylated surfactant is dissolved or dispersed in an aqueous solution.

6. The method of claim 1, wherein the branched alcohol ethoxylated surfactant is added to the treatment fluid before the treatment fluid is introduced into the well bore.

7. The method of claim 6, wherein the branched alcohol ethoxylated surfactant is incorporated into the treatment fluid in an amount from about 0.001% to about 2% by weight of aqueous or organic based fluid.

8. The method of claim 1, wherein the branched alcohol ethoxylated surfactant is added to the treatment fluid as a separate fluid after at least a portion the treatment fluid has been introduced into the wellbore.

9. The method of claim 8, wherein the branched alcohol ethoxylated surfactant is incorporated into an aqueous or organic based fluid in an amount from about 0.001% to about 2% by weight of aqueous or organic based fluid.

10. The method of claim 1, wherein the treatment is selected from fracturing treatment, acid treatment, gravel packing treatment, mud displacement treatment, fluid diversion treatment, cement spacing treatment, coil tubing clean-outtreatment, water control treatment, mud filter cake breaker treatment, and well drilling.

11. The method of claim 1, wherein the treatment fluid is selected from fracturing fluid, acid treatment fluid, gravel packing fluid, mud displacement fluid, diversion fluids, cement spacer fluid, coil tubing clean-out fluid, water control fluid, mud filter cake breaker fluid, and drilling fluid.

12. The method of claim 4, wherein f is an integer smaller than or equal to 3 and wherein x is an integer of from about 1 to about 12.

13. The method of claim 1, wherein the treatment fluid further comprises an alkyl polyglucoside surfactant.

14. The method of claim 1, wherein the treatment fluid further comprises particulates and or fibers.

15. The method of claim 1, wherein the branched ethoxylated alcohol surfactant is Guerbet C10 alcohol based branched nonionic surfactant based on ethoxylated branched 2-propylheptanol.
